(19) United States
(12) Patent Application Publication
(10) Pub. No.: US 2025/0258753 A1
(43) Pub. Date: Aug. 14, 2025

(54) PROGRAM DEVELOPMENT SUPPORT DEVICE, PROGRAM DEVELOPMENT SUPPORT METHOD AND COMPUTER READABLE MEDIUM

(71) Applicant: Mitsubishi Electric Corporation, Tokyo (JP)

(72) Inventor: Kiyohito MIYAZAKI, Tokyo (JP)

(73) Assignee: Mitsubishi Electric Corporation, Tokyo (JP)

(21) Appl. No.: 19/193,282

(22) Filed: Apr. 29, 2025

Related U.S. Application Data
(63) Continuation of application No. PCT/JP2023/013688, filed on Mar. 31, 2023.

(51) Int. Cl. G06F 11/3604

(52) U.S. Cl. CPC G06F 11/3608

(57) ABSTRACT

A program development support device (1) includes a program fragment database (1043) to register a list of a plurality of fragment side effects indicating multiple side effects included in a program fragment (F) corresponding to a mechanism element as multiple fragment side effects by associating the list of the plurality of fragment side effects with multiple program fragments (F), a program analysis unit (1041) to analyze a control program, and to create a program side effect list indicating multiple side effects included in the control program as multiple program side effects, and a similarity search unit (1042) to compare the multiple program side effects indicated in the program side effect list with the multiple fragment side effects indicated in the list of the plurality of fragment side effects, and to search for a program fragment (F) corresponding to the fragment side effect list in which the multiple fragment side effects are included in the multiple program side effects as a similar program fragment.

### CROSS REFERENCE TO RELATED APPLICATION

This application is a Continuation of PCT International Application No. PCT/JP2023/013688, filed on Mar. 31, 2023, which is hereby expressly incorporated by reference into the present application.

### TECHNICAL FIELD

The present disclosure relates to a program development support device, a program development support method and a program development support program.

The present disclosure relates to improving the efficiency of development of a control program in the fields of factory automation (FA) and process automation (PA).

### BACKGROUND ART

Machine tools and production lines (hereinafter collectively referred to as production equipment) are often controlled using a PLC (Programmable Logic Controller). Since the content of control varies depending on the production equipment, a machine tool manufacturer or systems integrator (hereinafter collectively referred to as a production equipment manufacturer) creates a control program according to the production equipment.

To improve the efficiency of development of the control program, the application of model-based development is spreading in some areas.

As of 2022, the application range of model-based development is limited, and it cannot be said that the model-based development is widely applied to the development of production equipment and control programs. Therefore, in the overall production equipment in the market, the proportion of development assets where model-based development is not applied (hereinafter referred to as existing development assets) is large. Considering the needs for improving efficiency in business in recent years, it is preferable to convert the existing development assets into development assets to which model-based development is applied (hereinafter referred to as model-based development assets) to utilize them for subsequent model modification and model diversion development.

It would be useful if a control program, which is an existing development asset, could be converted into a model-based development asset. However, manual conversion work requires a significant amount of labor, and no technology is known to perform conversion without manual intervention.

To restore a model from a control program, it is necessary to restore the intent of the developer that has led to the generation of the control program. However, information is often lost due to the replacement of engineers, and supplementary information (labels, comments) or design documents in the control program, which serve as clues for analysis, are often insufficient.

Therefore, as a result, it is often judged that the effect obtained does not justify the amount of labor input. Moreover, since it is necessary to restore the intent of the developer, and deriving a model from the control program is not a problem that can be deterministically solved, no technology is known to perform conversion with software.

### CITATION LIST

### Patent Literature

Patent Literature 1: JP 2001-306108 A

### SUMMARY OF INVENTION

### Technical Problem

In Patent Literature 1, a method for creating a control program is disclosed, characterized by storing a state transition diagram, which is a type of model, in association with the control program. The state transition diagram needs to be created and edited in advance by the user on the screen, and Patent Literature 1 mentions generating a control program from the state transition diagram. On the other hand, there is no mention of models other than the state transition diagram.

Even with the technology disclosed in Patent Literature 1, there is no disclosure or suggestion about deriving a state transition diagram from a control program.

The problem the present disclosure is aimed at solving is to detect program fragments, which are the constituent units of a model, from an existing control program without assuming that design information of production equipment is attached to the control program, and to generate a control program model.

### Solution to Problem

There is provided according to the present disclosure a program development support device includes
a program fragment database to register a list of a plurality of fragment side effects indicating a plurality of side effects that are included in a program fragment corresponding to a mechanism element, as a plurality of fragment side effects, by associating the list of the plurality of fragment side effects with a plurality of program fragments,
a program analysis unit to analyze a control program, and to create a program side effect list indicating a plurality of side effects that are included in the control program as a plurality of program side effects, and
a similarity search unit to compare the plurality of program side effects indicated in the program side effect list with the plurality of fragment side effects indicated in the list of the plurality of fragment side effects, and to search for a program fragment corresponding to a fragment side effect list where the plurality of fragment side effects are included in the plurality of program side effects, as a similar program fragment.

### Advantageous Effects of Invention

In the present disclosure, a similarity search unit can detect a program fragment, which constitutes a model, from an existing control program by comparing side effects of the existing control program and the program fragment.

### BRIEF DESCRIPTION OF DRAWINGS

FIG. 1 is a diagram illustrating an example of a control program;

FIG. 2 is a diagram illustrating an example of a block definition diagram;

FIG. 3 is a diagram illustrating an example of an internal block diagram;

FIG. 4 is a diagram illustrating an example of a state transition diagram;

FIG. 5 is a diagram illustrating a system configuration;

FIG. 6 is a diagram illustrating a configuration of an engineering workstation 9;

FIG. 7 is a diagram illustrating a configuration of a program development support device 1;

FIG. 8 is a diagram illustrating a configuration of a model extraction unit 104;

FIG. 9 is a diagram illustrating a mechanism element side effect table;

FIG. 10 is a diagram illustrating a structure of a program fragment database 1043;

FIG. 11 is a flowchart illustrating an operation of a program analysis unit 1041;

FIG. 12 is a diagram illustrating an example of a program list converted into text by the program analysis unit 1041;

FIG. 13 is a diagram illustrating an example of a variable abstraction table by the program analysis unit 1041;

FIG. 14 is a diagram illustrating an example of a program after normalization and abstraction by the program analysis unit 1041;

FIG. 15 is a diagram illustrating an example of a side effect subject substitute variable by the program analysis unit 1041;

FIG. 16 is a diagram illustrating an example of a program side effect list by the program analysis unit 1041;

FIG. 17 is a diagram illustrating an example of a program side effect dependency of a program side effect by the program analysis unit 1041;

FIG. 18 is a diagram illustrating a program dependency graph of program side effects by the program analysis unit 1041;

FIG. 19 is a diagram illustrating an example of a side effect list after program normalization by the program analysis unit 1041;

FIG. 20 is a diagram illustrating a relation of information by the program analysis unit 1041;

FIG. 21 is a flowchart illustrating an operation of a similarity search unit 1042;

FIG. 22 is a diagram illustrating a determination example of side effect search by the similarity search unit 1042;

FIG. 23 is a diagram illustrating a data configuration of search results by the similarity search unit 1042;

FIG. 24 is a diagram illustrating an example of a search result table by the similarity search unit 1042;

FIG. 25 is a diagram illustrating an example of a search result correspondence table by the similarity search unit 1042;

FIG. 26 is a diagram illustrating an example of a side effect consistency table by the similarity search unit 1042;

FIG. 27 is a diagram illustrating another example of the side effect consistency table by the similarity search unit 1042;

FIG. 28 is a diagram illustrating a side effect combination list by a mechanism element estimation unit 1044;

FIG. 29 is a diagram illustrating a structure of a model database;

FIG. 30 is a diagram illustrating a model database management table;

FIG. 31 is a diagram illustrating a monitor screen by a model configuration unit 1045; and

FIG. 32 is a diagram illustrating a monitor screen by the model configuration unit 1045.

### DESCRIPTION OF EMBODIMENTS

Hereinafter, an embodiment of the present disclosure will be described using the drawings. In each diagram, the same or corresponding parts are denoted by the same reference numerals. In the description of the embodiment, the explanation of the same or corresponding parts will be omitted or simplified as appropriate.

### First Embodiment

In this embodiment, description will be made on the premise that the control program is a program developed using a graphical programming language called a ladder diagram, which simulates an electrical circuit. In addition, four other languages are standardized by IEC (International Electrotechnical Commission) 61131-3, and the target of the present embodiment is not limited to ladder diagrams.

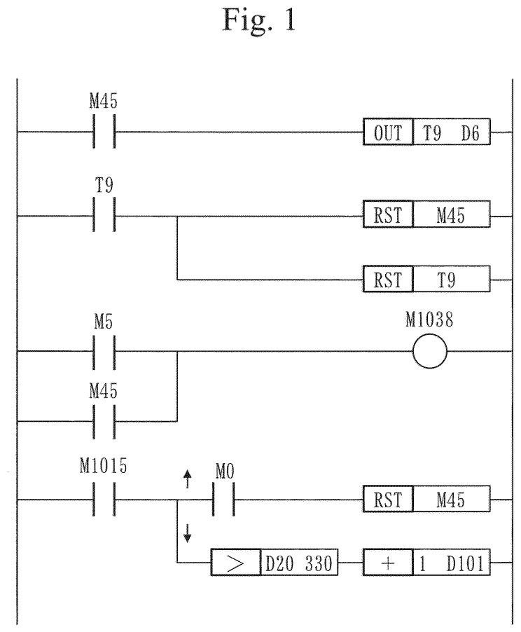

An example of a control program created with a ladder diagram is illustrated in FIG. 1.

The language specification of the ladder diagram is left to IEC61131-3 and other literature; however, its outline is as follows.
The lines in the horizontal direction in the program are connection lines.
The left side of the connection line is a conditional statement, and the right side is an imperative statement. When the conditional statement is satisfied, the imperative statement on the connection line is executed.
Conditional statements described in parallel by integration of connection lines become OR conditions. That is, if one or more conditional statements are satisfied, the imperative statement is executed.
Conditional statements described in series on the connection line become AND conditions. That is, if all conditional statements are satisfied, the imperative statement is executed.
Imperative statements described in parallel by branching of the connection line are all executed when the conditional statement is satisfied.

The control program created is executed by a controller. The control program is implemented to be executed within a predetermined time constraint at a constant period or on an event-driven basis. Typically, the control program is repeatedly executed at a constant period called a basic processing cycle set.

Based on the original concept of the ladder diagram simulating an electrical circuit, there is no order relation between parallel connection lines, and the execution timings of conditional statements and imperative statements on each connection line are in parallel. However, in actual controllers, since the control program is executed using a finite number of processor cores, the control program is often sequentially executed as if there is an order from the upper connection line to the lower connection line. The result of control may change due to behavior of such a sequential execution order, and there may be differences in behavior depending on the manufacturer or model of the controller; however, such differences in behavior are rarely considered in practice.

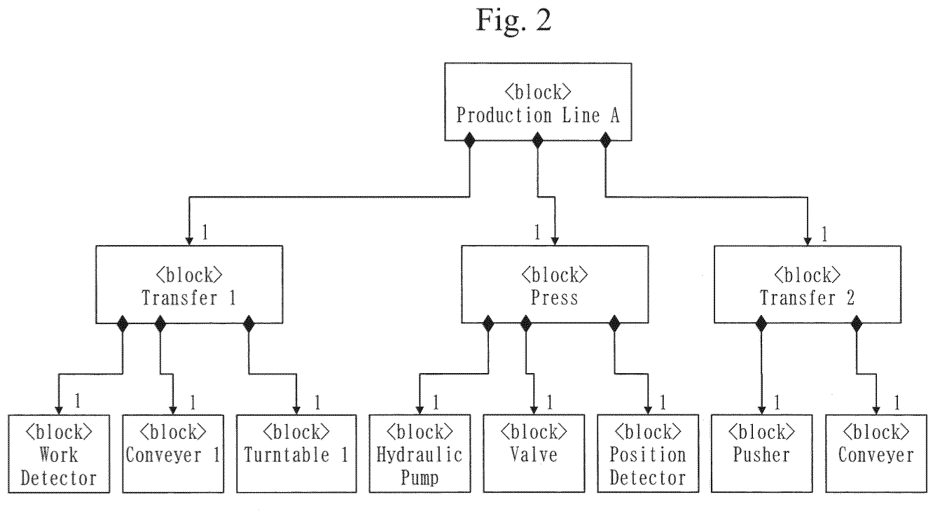

In model-based development, production equipment is described at the design stage in a SysML (Systems Modeling Language) or by other abstract models, and based on that model, automatic design of mechanical or electrical equipment and automatic generation of control programs can be achieved, and the efficiency can be improved. By describing the production equipment with a model, its modification and diversion development can also be made more efficient. The SysML defines several types of models; however, the following three types are effective models for automatic generation of control programs. Examples of these models are briefly shown and described below.
Block definition diagram (BDD).
Internal block diagram (IBD).
State machine diagram (STM).
   An example of the block definition diagram is illustrated in FIG. 2.

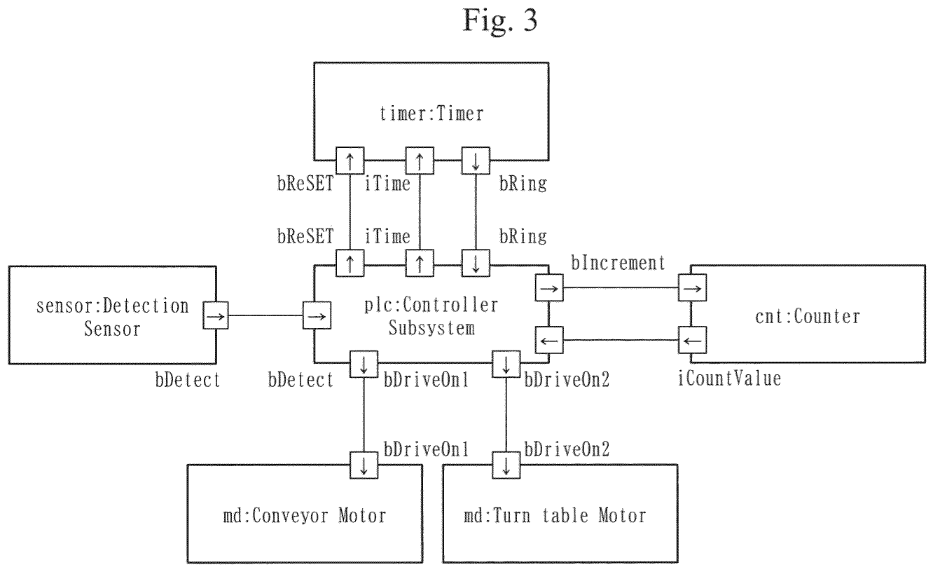

FIG. 2 is a diagram illustrating the configuration relation of production equipment. Production line A (Production Line A) is constituted of one conveyance system 1 (Transfer 1), one press machine (Press), and one conveyance system 2 (Transfer 2). Furthermore, it is illustrated that the conveyance system 1 is constituted of three subsystems: a work detector (Work Detector), a conveyor 1 (Conveyor 1), and a turntable 1 (Turntable 1). The press machine and the conveyance system 2 also have a hierarchical structure likewise.
An example of an internal block diagram is illustrated in FIG. 3.

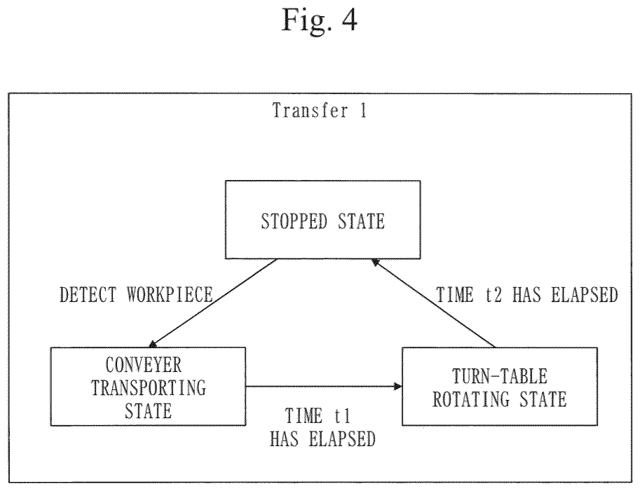

FIG. 3 is a diagram illustrating an internal configuration and connection relations of the conveyance system 1. The conveyance system 1 is centered around a controller subsystem (Controller Subsystem). FIG. 3 illustrates that a detection sensor (Detection Sensor) is connected to the controller subsystem, and the controller subsystem uses input information bDetect from the detection sensor for control.
An example of a state transition diagram is illustrated in FIG. 4.

FIG. 4 is a diagram illustrating a state transition of an operation of the conveyance system 1. The conveyance system 1 has three states: a stopped state, a conveyor transporting state, and a turntable rotating state, and it is illustrated that when a workpiece is detected in the stopped state, the state transitions to the conveyor transporting state.

### Problems the Embodiment Aims to Solve

The problem that the present embodiment is aimed at solving is to generate a control program model based on an existing control program without assuming that design information of production equipment is attached to the control program.

The problem that the present embodiment is aimed at solving can be subdivided into the following two parts.

(Sub-Problem 1) Detecting Program Fragments that Constitute the Control Program Model from within the Control Program

A control program can be extensive, constituted of thousands to tens of thousands of lines, often containing therein control processes for a plurality of subsystems. Since the control program can be implemented with flexibility depending on the developer, the control program is not necessarily organized into files or consecutive lines for each target subsystem. It is impossible to generate a model without organizing the control program into meaningful units. Therefore, the first challenge is to divide the control program into blocks, which are meaningful units corresponding to subsystems.

(Sub-Problem 2) Generating a Control Program Model from Program Fragments

Program fragments merely represent the content of control processes and do not represent highly abstract block definitions or state transitions. Therefore, the second challenge is to generate a control program model from the program fragments. In generating the model, it is necessary to ensure that a model can be derived according to behavior even when descriptions of the program fragments differ, considering that program fragments behaving in the same way can be described countlessly. That descriptions of the program fragments can be considered countlessly is not limited to assignment of variables used and minor differences in conditional statements, but descriptions different at the syntax level can be also considered; therefore, it is impossible to confirm behavioral identity through simple match comparisons using wildcard searches and other searches.

### Description of Configuration of Embodiment

The embodiment of the present embodiment will be described. Note that the content described in the present embodiment does not limit the scope of the present disclosure.

The production equipment controlled by the control program (hereinafter referred to as a control target) is a combination of mechanical mechanisms or electric circuits (collectively referred to as mechanism elements).

A part (fragment) of the control program and the entire control program together are referred to as the control program.

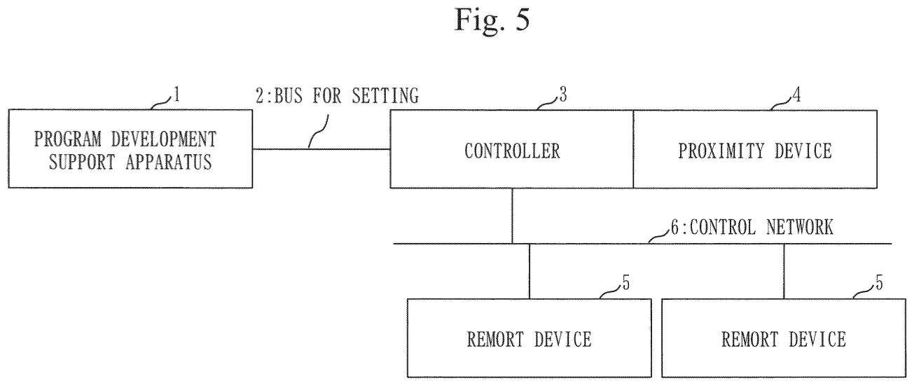

The program development support device 1 of the present embodiment is used in a system configuration as illustrated in FIG. 5.

The program development support device 1 is connected to a controller 3 via a bus for setting 2 and is a device to perform program development executed by a controller to control production equipment.

The bus for setting 2 is a serial bus, a wired network, or a wireless network. The bus for setting 2 is used for writing programs to the controller 3 and can be disconnected when not in use. Note that the bus for setting 2 may be replaced with a storage medium or another means that can be used for program transfer.

The controller 3 controls the production equipment. A proximity device 4 and a remote device 5 are various devices that input and output information to and from the controller 3 and operate based on commands from the controller 3.

The proximity device 4 is installed near the controller 3 via a backplane bus.

The remote device 5 is connected to the controller 3 via a control network 6.

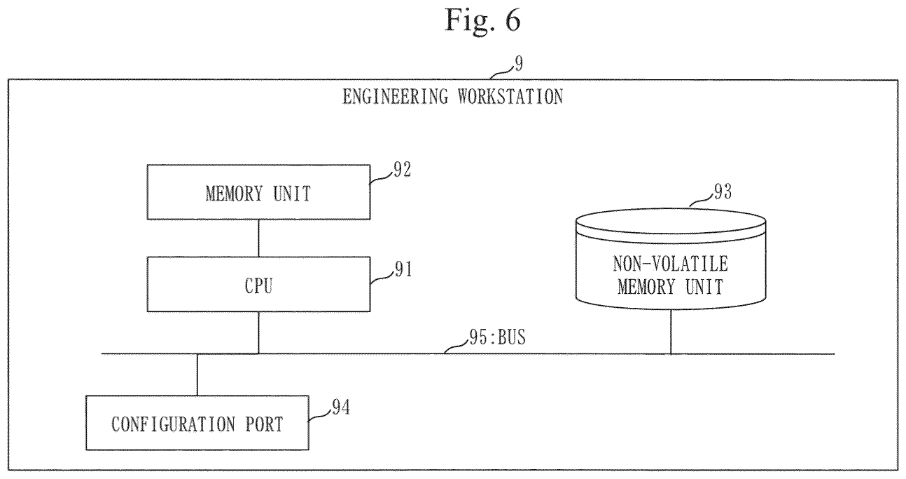

The program development support device 1 is an engineering workstation 9 with the configuration illustrated in FIG. 6, executing program development support software. The engineering workstation 9 is a general-purpose computer.

In the engineering workstation 9, a CPU 91, a memory unit 92, a non-volatile memory unit 93, and a configuration port 94 are connected to a bus 95.

The engineering workstation 9 can be used in any form as long as it has the resources necessary to execute the program development support software.

The engineering workstation 9 may be a desktop type computer, notebook type computer, a tablet type computer, or a virtual computer executed in the cloud.

The engineering workstation 9 may be accelerated the process by a parallel computing accelerator such as a multi-processor, a multi-core processor, a GPU (Graphics Processing Unit), or quantum and pseudo-quantum processing technology.

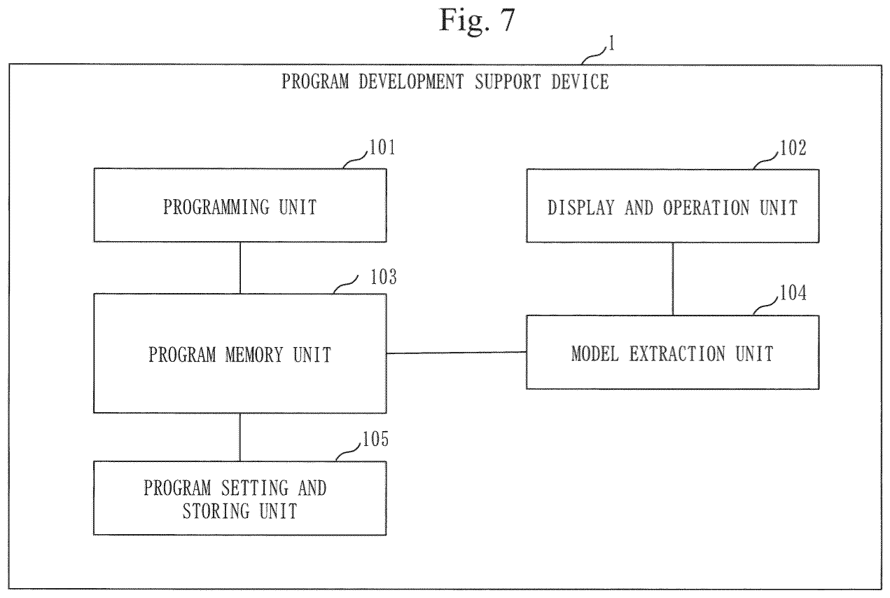

The configuration of the program development support device 1 realized by executing the program development support software described above is as illustrated in FIG. 7.

A programming unit 101 provides a means for developers to create or edit control programs and is realized with a program editor or other editors.

The programming unit 101 is based on enabling programming in all or a part of the five languages, including the ladder diagram standardized by IEC61131-3.

The programming unit 101 may correspond to other languages as long as the language can describe the control program.

A program memory unit 103 is a storage area to store the control program developed by developers using the programming unit 101 temporarily during the creation and editing process, or permanently after creation. The control program represents the entire series of programs that control the production equipment, and is generally stored, saved and managed under the name of a project.

A program setting and storing unit 105 permanently stores the program in the program memory unit 103. Alternatively, the program setting and storing unit 105 provides a function to write to the controller 3 via the configuration port 94.

A model extraction unit 104 is a means to analyze the control program present in the program memory unit 103, and to extract a model.

The model extraction unit 104 generates a block definition diagram, an internal block diagram and a state transition diagram, which are models corresponding to the control program.

The model extraction unit 104 is an element to constitute the feature of the present embodiment and is constituted by a plurality of components, which will be described separately in detail.

A display and operation unit 102 is a means to provide developers with display and operation of processes and results related to model extraction using a monitor, a keyboard, and a mouse.

The display and operation unit 102 is also a means to register to a program fragment database 1043 and a model database 1046.

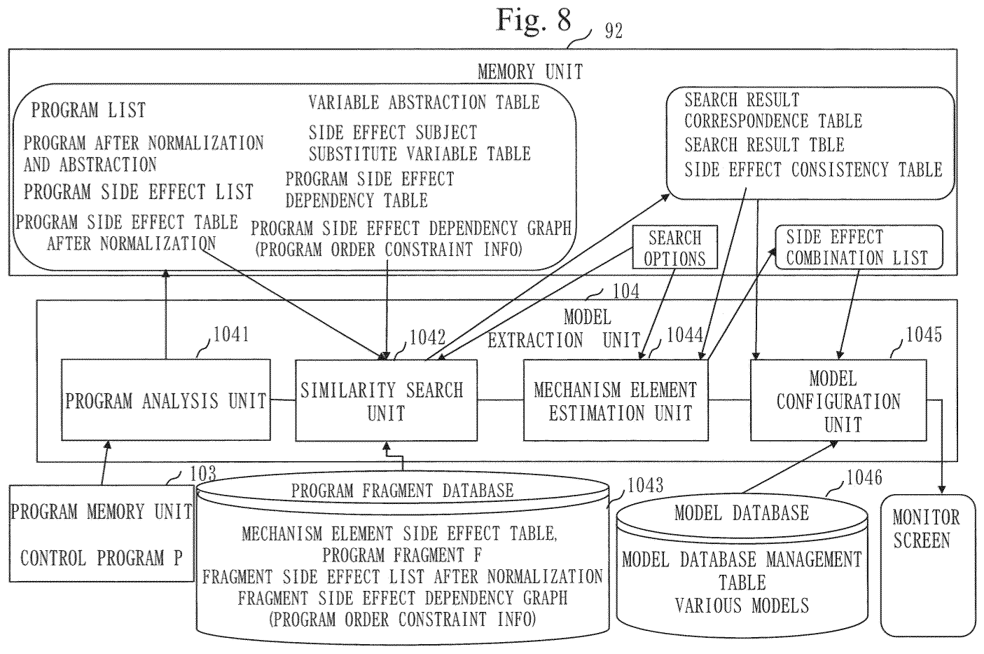

An internal configuration of the model extraction unit 104 is illustrated in FIG. 8.

The outline of the functions of each part is as follows.

A program analysis unit 1041 converts a control program P into a form from which side effects have been extracted to facilitate similarity searches.

A similarity search unit 1042 uses the output of the program analysis unit 1041 and the program fragment database 1043 to search for program fragments in the control program P that have side effects equivalent to the mechanism elements registered in the program fragment database 1043, obtaining a list of matching search results.

A mechanism element estimation unit 1044 estimates which combination of mechanism elements constitutes the control program P based on the list of search results. Since the search results may include combinations of mechanism elements that cannot coexist in the control program, the mechanism element estimation unit 1044 eliminates such combinations of mechanism elements that cannot coexist.

A model configuration unit 1045 searches for models corresponding to the mechanism elements estimated by the mechanism element estimation unit 1044 in the model database 1046, and estimates the model of the entire control program by estimating these connection relations.

The “unit” of each unit of the program analysis unit 1041, the similarity search unit 1042, the mechanism element estimation unit 1044 and the model configuration unit 1045 may be replaced with “process,” “procedure” or “step”.

Additionally, a program development support method is a method performed by executing the program development support program.

The program development support program causes a computer to execute each process, each procedure or each step, which is the “unit” of each unit above replaced by “process,” “procedure” or “step”.

The program development support program may be provided as a program product or a computer-readable non-volatile recording medium recording the program.

The functions of the program analysis unit 1041, the similarity search unit 1042, the mechanism element estimation unit 1044 and the model configuration unit 1045 may be realized by a single electronic circuit or being distributed across a plurality of electronic circuits.

Some functions of the program analysis unit 1041, the similarity search unit 1042, the mechanism element estimation unit 1044 and the model configuration unit 1045 may be realized by electronic circuits, while the remaining functions may be realized by software.

Some or all functions of the program analysis unit 1041, the similarity search unit 1042, the mechanism element estimation unit 1044 and the model configuration unit 1045 may be realized by firmware.

Each of the processor 901 and electronic circuits may be called processing circuitry.

The functions of the program analysis unit 1041, the similarity search unit 1042, the mechanism element estimation unit 1044 and the model configuration unit 1045 are realized by the processing circuitry.

The program fragment database 1043 and the model database 1046 are stored in the non-volatile memory unit 93 (or the memory unit 92).

Additionally, various lists, various tables and various graphs described below are stored in the memory unit 92 (or the non-volatile memory unit 93) in list format, tabular format, or file format.

### Similarity Search

Although differences in details may be considered depending on the control target, there are standard patterns in mechanism elements, and the standard patterns can be categorized. Therefore, control programs for controlling the similar type of mechanism elements are expected to have similar control content. Thus, a program fragment database 1043 is provided to record fragments of control programs (program fragments F) that control the standard mechanism elements. If there is a fragment in the control program similar to a program fragment F registered in the program fragment database 1043, that program fragment F is searched as a similar program fragment.

During the search, in order to perform a similarity search that absorbs differences due to developers or production equipment in the implementation of the control program, the program analysis unit 1041 and the similarity search unit 1042 are provided to perform the similarity search based on the “side effects” caused by the program fragment F.

### Side Effects and Order Constraints

Side effects are a term in the programming field, referring to the impact of a program to change variables etc. inside or outside the program. Specifically, side effects refer to changes in values of variables or values of port numbers.

Here, even if control programs are completely different at the syntax level, if the changes in variables resulting from execution thereof are the same, the side effects are considered to match. Since variable names and port numbers that are used vary depending on developers, side effects are considered to match if only the correspondence relations of variables and ports match.

The similarity search unit 1042 searches the control program to be searched in for a fragment similar to the program fragment F to search for, from the following perspectives.

(1) Sameness of a plurality of side effects: Whether the control program contains a plurality of side effects identical to those of the program fragment F.

(2) Sameness of the order constraints of a plurality of side effects: Whether the control program contains a plurality of side effects with the same order constraints as a plurality of side effects of the program fragment F.

The similarity search unit 1042 performs search for program fragments while allowing the following differences in the control program as long as the order constraints are satisfied.
Rearrangement of processing order in the control program.
Replacement of instructions used in the control program. The same side effect may occur by different instructions.
Insertion of processing unrelated to side effects in the control program is allowed.

Side effects are structured and defined as data representing changes in values of variable or output ports before and after the execution of the basic processing cycle of the control program. Side effects are not limited to what make results definitive, such as changing data X from 0 to 1. Therefore, a data configuration that can define side effects where the way data changes varies depending on conditions or where changes are expressed by formulas rather than constants is adopted.

The reason for extracting information on order constraints of a plurality of side effects in addition to side effects is to distinguish whether the execution result of a single basic processing cycle is completely maintained or different. Some control programs may achieve side effects over multiple basic processing cycles.

Specifically, there may be a case where the control program is programmed in such a manner that the processing content that can be programmed to obtain side effects in only one basic processing cycle is obtained by manipulating only internal variables in the first basic processing cycle, and by outputting the result to external variables in the second basic processing cycle if the condition of the internal variables is met.

More specifically, in a control program where a side effect on a variable A occurs first, and a side effect on a variable B occurs depending on the change in the value of the variable A, if the side effect on the variable A occurs first, side effects on both the variable A and the variable B occur as a result of one basic processing cycle.

On the other hand, in a control program where the order of side effects is reversed, and the side effect on the variable B occurs first according to change in the value of the variable A, followed by the side effect on the variable A, only the side effect on the variable A occurs in the first basic processing cycle, and the side effect on the variable B occurs in the second basic processing cycle.

In the latter case, the same result as that of one basic processing cycle of the former case is obtained through two basic processing cycles. In such cases, the time required for processing differs between the former and latter cases. However, since the time taken by the basic processing cycle is generally small, such as in milliseconds, and the input and output of data in the control program may be performed at a longer cycle than the basic processing cycle, even if the time required for processing is different, it often results in equivalent outcomes in production equipment control. Thus, even for program fragments where the same side effects are obtained despite differing numbers of required basic processing cycles, there is room to allow for differences.

### Model Configuration

In the model database 1046, a plurality of models are stored in association with a plurality of program fragments F, and the model configuration unit 1045 extracts a model from the model database 1046. Furthermore, the model configuration unit 1045 analyzes the connection relations of the plurality of models extracted from the control program, and configures the model as an entire control program.

The results obtained by the model configuration unit 1045 are displayed to the user by the display and operation unit 102. Additionally, by storing the result in the storage unit via the program setting and storing unit 105, it is possible to repurpose the model in development of other control programs. If the model cannot be uniquely identified during the extraction process of the model, the model may be specified from multiple options via the display and operation unit 102.

### Description of Operation of Model Extraction Unit 104

The following describes each part of the model extraction unit 104. In the following, the entity (subject) of the operation of each unit is basically the subject of explanation in each paragraph.

### Program Fragment Database 1043

The program fragment database 1043 stores a plurality of program fragments F corresponding to a plurality of standard mechanism elements.

The program fragment database 1043 stores a plurality of program fragments F in association with a plurality of mechanism element identifiers (mechanism element serial numbers) indicated in a mechanism element side effect table.

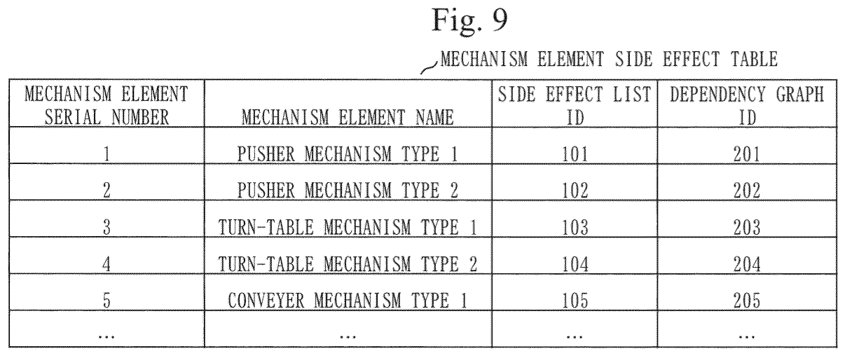

The program fragment database 1043 stores, in association with mechanism elements, a side effect list for each mechanism element (hereinafter referred to as a fragment side effect list) and a side effect dependency graph for each mechanism element (hereinafter referred to as a fragment side effect dependency graph) as illustrated in FIG. 9.

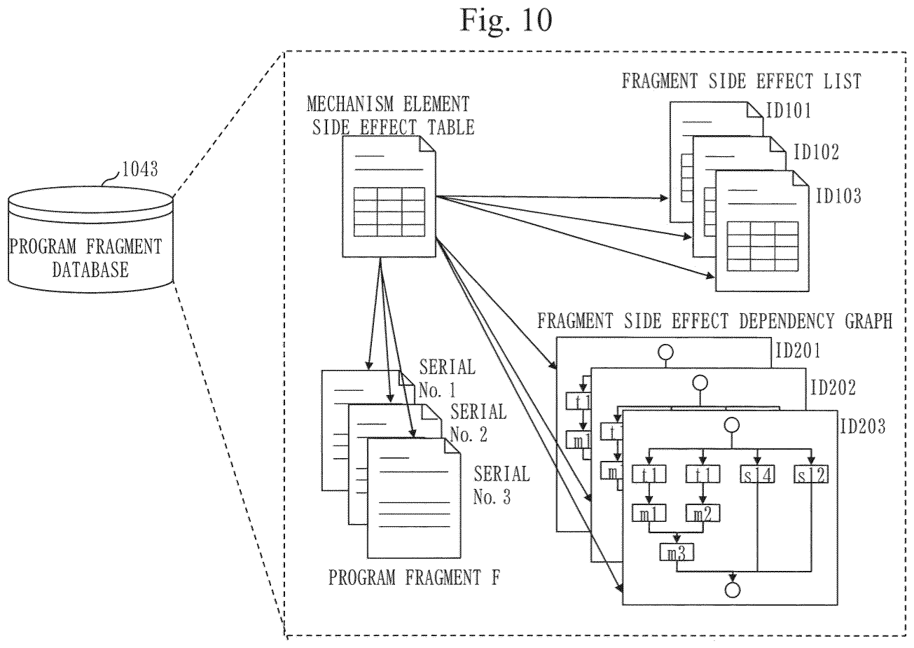

As illustrated in FIG. 10, the program fragment database 1043 stores the program fragment F, the fragment side effect list and the fragment side effect dependency graph for each mechanism element.

Program fragments F for standard mechanism elements are widely published in numerous types in reference books on control programs for developers, and it is possible to conceive a method of predefining the program fragment database 1043 based on them. Additionally, when developing production equipment that handles non-standard mechanism elements, it is also conceivable to register program fragments F in the program fragment database 1043 by the developer.

The fragment side effect list and the fragment side effect dependency graph can be created by inputting the program fragment F instead of the control program P into the program analysis unit 1041 described below.

### The Program Analysis Unit 1041

The program analysis unit 1041 generates side effect order constraint information of the control program P (the fragment side effect list after normalization of the control program P and the program side effect dependency graph of the control program P, to be described later) using the control program P as input. Examples will be described separately.

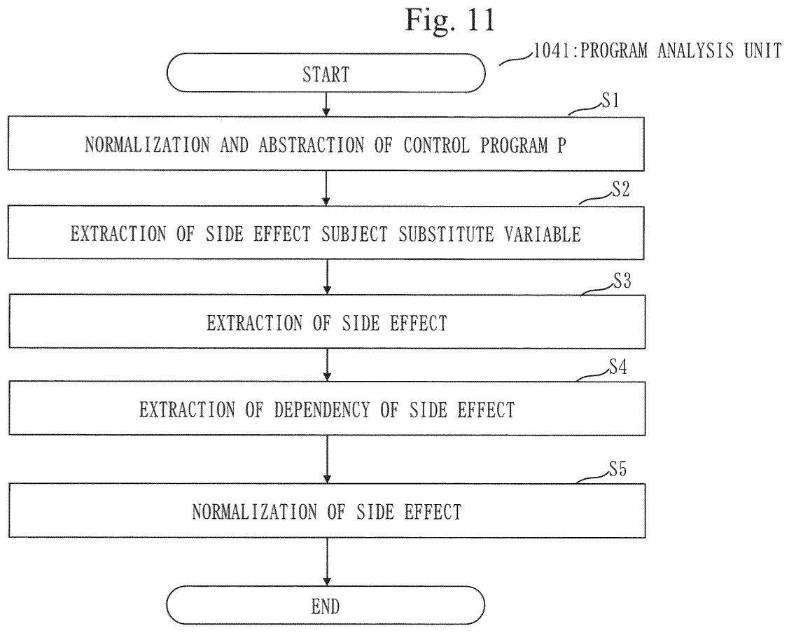

The flow of operation of the program analysis unit 1041 is illustrated in FIG. 11.

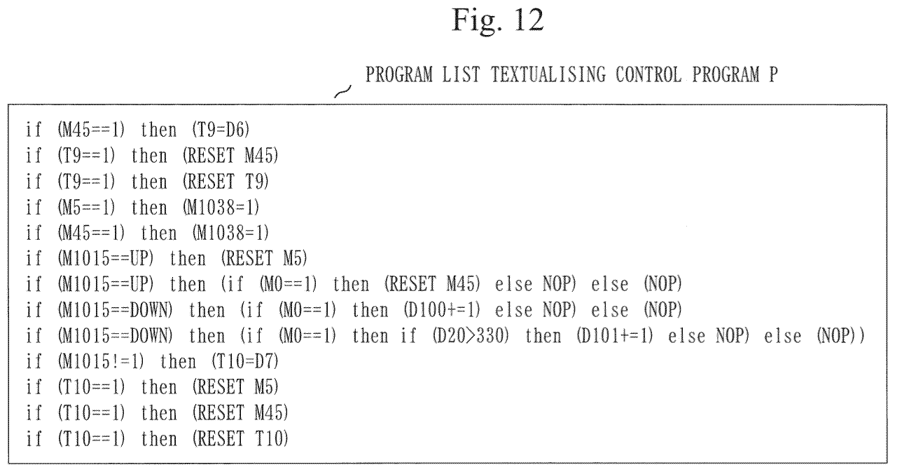

The control program P analyzed by the program analysis unit 1041 is assumed to be loaded into the program memory unit 103 beforehand. The program memory unit 103 is assumed to store a program list (the program list illustrated in FIG. 12) converted into text from the control program P in FIG. 1.

### Step S1: Normalization and Abstraction of Control Program P

As a preprocessing step, the program analysis unit 1041 normalizes the control program P into a program sequence that can be handled as a string, whereof description is constrained according to certain rules, and simultaneously abstracts the control program P by replacing variables and port numbers in the control program with implementation-independent substitute variables. The substitute variables refers to variables that replace the variables implemented in the control program P. The result of these processes is called a program after normalization and abstraction.

The conversion rules for normalization can be freely set as long as the conversion rules suppress variations in program description, where one example is as follows:
Organize conditional statements so that a single conditional statement does not include compound conditions. Specifically, the AND condition of multiple conditions is organized into a combination of conditional statements in multiple layers. Also, the OR condition of multiple conditions is divided into parallel multiple conditional statements.
If there are a plurality of side effects under the same condition, divide the plurality of side effects so that there is one statement for each variable or output port.
Variables or output ports are replaced with temporary variables of the same type as the original type. Type (type) is a general programming term that represents the meaning of data. Specifically, there are types such as 1-bit data, 16-bit unsigned discrete values, or 32-bit signed floating-point numbers.
Fixed values (magic numbers) are turned into specific variables representing fixed values.

An example of abstraction will be described. Hereinafter, variables and port numbers are collectively referred to as variables.

The program analysis unit 1041 replaces a plurality of variables used in the control program P with a plurality of substitute variables, and creates a variable abstraction table indicating the correspondence relation of replacements.

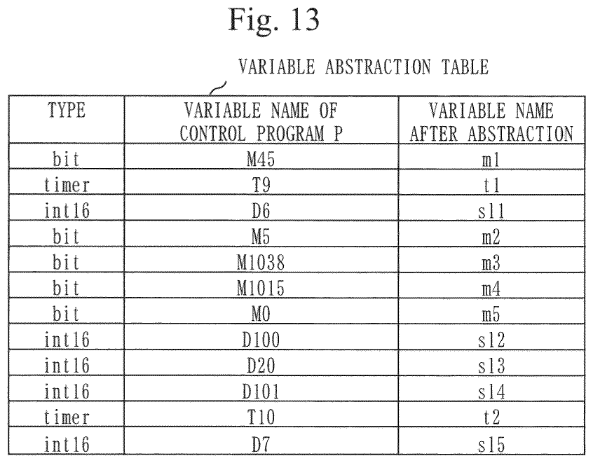

An example of the variable abstraction table is illustrated in FIG. 13.

In the “Variable Name in Control Program P” column, a plurality of variables appearing in the control program are listed in order of appearance without duplication. There are no particular restrictions on the order of listing in the variable abstraction table.

In the “Type” column, the types of the listed variables are described. The type is determined for each variable at the programming stage. The types include those mentioned in the example, as well as the following:
bit: 1-bit data.
intN: Signed N-bit integer. N is generally 8, 16, 32 or 64.
uintN: Unsigned N-bit integer. N is generally 8, 16, 32 or 64.
timer: Timer. 1-bit data that becomes 1 after the set time has elapsed and 0 otherwise.

The “Variable Name after Abstraction” lists the names of the substitute variables for the variables appearing in the control program P, and should be assigned without duplication. Here, a substitute variable name combining an alphabet prefix determined by the type and a numeric suffix representing the order of appearance of variables for each type is used. Here, the prefix m is used for bit type, t for timer type, and sl for signed 16-bit integer type.

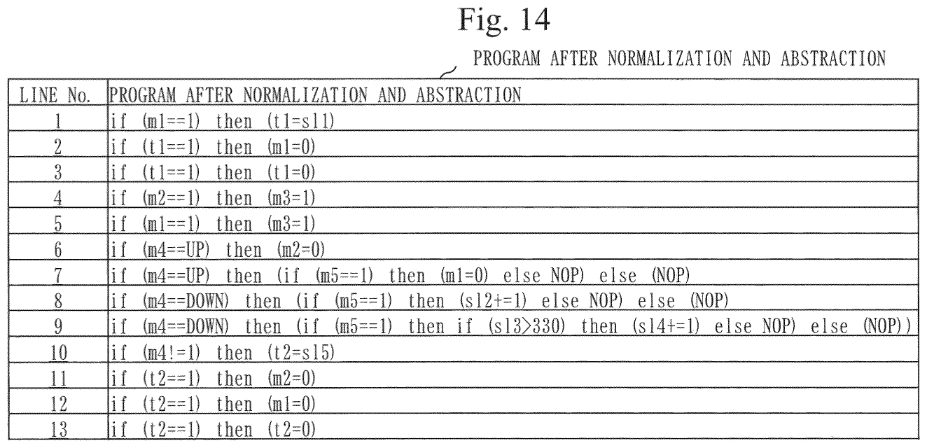

An example of the program after normalization and abstraction is illustrated in FIG. 14.

By using the variable abstraction table, variables are replaced with substitute variables in the program list. Also, instructions such as RESET and ADD are replaced with numerical assignment statements.

According to the above, the program after normalization and abstraction illustrated in FIG. 14 is obtained.

### Step S2: Extraction of Side Effect Subject Substitute Variable

The program analysis unit 1041 extracts side effect subject substitute variables, which enumerate the substitute variables subject to change, from the program after normalization and abstraction in order to organize the changes in the values of variables being side effects. In other words, the side effect subject substitute variables are substitute variables corresponding to variables that are rewritten by execution of the control program P, and do not include variables that are only referred to, but not changed by the execution of the control program P. However, even under a rare condition, if a variable is subject to rewriting, the variable is included in the side effect subject substitute variables.

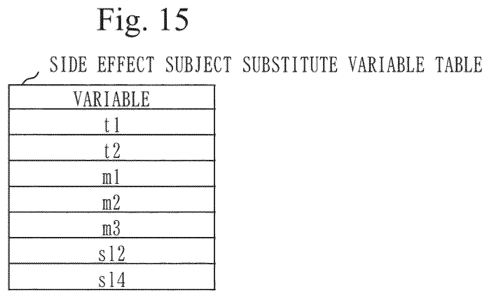

An example of the extraction of side effect subject substitute variables is illustrated in FIG. 15.

A side effect subject substitute variable table is to extract all variables to which values are assigned in the instruction part of the program after normalization and abstraction. Variables that are only referred to are not included in the side effect subject substitute variable table.

### Step S3: Extraction of Side Effect

The program analysis unit 1041 enumerates side effects in one basic processing cycle, i.e., change results for each condition, with respect to the side effect subject substitute variables illustrated in FIG. 15.

The program analysis unit 1041 describes the side effect for each condition so that the side effect for each condition are complete for each side effect subject substitute variable. In other words, while the program after normalization and abstraction has described the processing flow as the control program P, in the present Step 3, the change results organized for each side effect subject substitute variable are described.

Regarding side effects, there are cases where the conditions or output values of the side effects are not fixedly determined in the control program, but depend on the results of other side effects. In such cases, the side effects necessary to obtain the conditions or the output values are also extracted. On the other hand, side effects on variables, etc., that do not affect the side effects with respect to the side effect subject substitute variables do not need to be extracted as side effects.

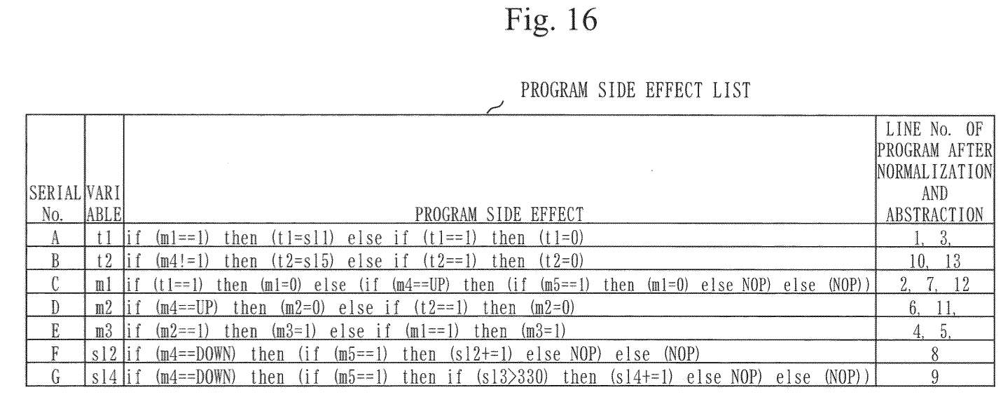

An example of extraction of side effects is illustrated in FIG. 16. The program side effect list in FIG. 16 aggregates changes in values that occur for each of the plurality of side effect subject substitute variables. For clarity, the column “corresponding line number of program after normalization and abstraction” indicates the line numbers of the control program P where the side effect are described (line numbers of the program list).

The program side effect list indicates the following:

Serial number: A serial number assigned to the program side effect. Identifier of the program side effect.

Variable: The variable whose value is changed by the program side effect.

Program side effect: The program side effect of the control program P.

Line number of the program after normalization and abstraction: The line number of the program list where the side effect of the control program P is described.

### Step S4: Extraction of Side Effect Dependencies of Side Effect

The program analysis unit 1041 organizes the multiple program side effects extracted in the program side effect list into serial order if the program side effects are necessary to be maintained the order dependencies so as to obtain equivalent side effects, and into parallel order if the program side effects are unnecessary to be maintained the order dependencies. These multiple program side effects which have been organized the order dependencies can be represented, for example, in a directed graph structure.

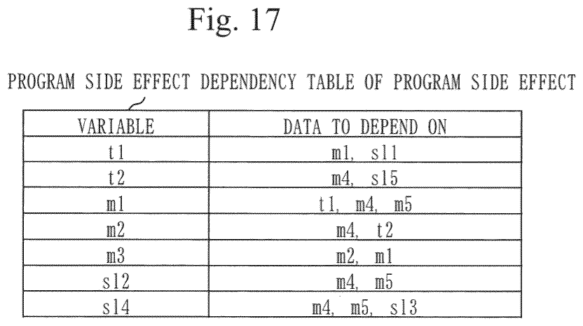

A table indicating the order dependencies of multiple program side effects is illustrated in FIG. 17.

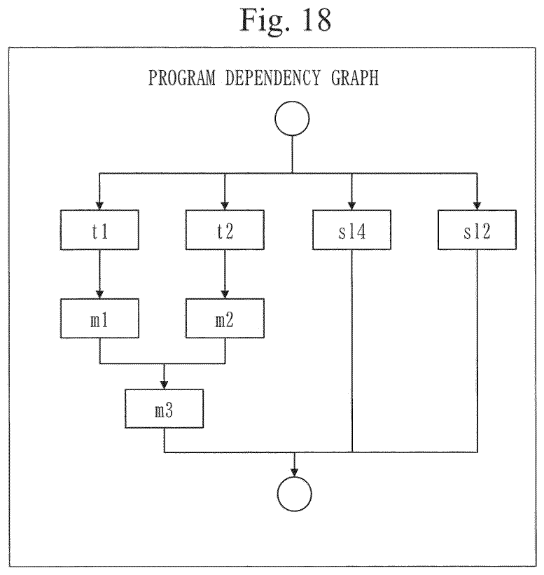

The program side effect dependency table illustrated in FIG. 17 represents which substitute variables are referred to by the side effects with respect to the side effect subject substitute variables. Specifically, with respect to the side effect on t1, m1 and sl1 are referred to. These dependencies are illustrated in a directed graph in FIG. 18 as a program side effect dependency graph. The program side effect dependency graph represents the dependencies with arrows, using the side effect subject substitute variables indicated in FIG. 17 as nodes, from which substitute variables that are not side effect subjects (m4, m5, sl1, sl3 and sl5) are excluded.

The program side effect dependency graph is order constraint information (hereinafter referred to as program order constraint information) that represents the order constraint relations of side effects to ensure the equivalence of side effects in the control program P.

### Step S5: Normalization of Side Effects

The program analysis unit 1041 normalizes the side effects after extraction of the dependencies according to normalization rules separately defined so that synonymous conditions are expressed in a unified description, and synonymous side effects are expressed in a unified description. Examples of normalization rules are as follows.
Inequalities are expressed only with less than “<” or less than or equal to “≤”, and inequalities with only integers are expressed using only less than “<”. Specifically, the inequality 2≥X using only integers is expressed as X<3. Also, the floating-point inequality 3.6≥X is replaced with X≤3.6.
Identical equations and pre-computable expressions are replaced with the results of the expressions, and conditional statements are omitted. Specifically, the first expression below is replaced with the second expression.

$$if ( 2 > 1 ) then ( X = 0 ) else ( NOP ) \qquad First expression$$

$$X = 0 \qquad Second expression$$

Instructions that output values such as OUT, RESET, SET, etc., are replaced with assignment statements. Specifically, since RESET X is an imperative statement to set X to 0, RESET X is replaced with X=0, which assigns 0 to X.
Conditional statements using the inequality “!=” are replaced with conditional statements using equality. Specifically, the first expression below is replaced with the second expression.

$$if ( X != 1 ) then ( Y = 1 ) else ( Z = 1 ) \qquad First expression$$

$$if ( X == 1 ) then ( Z = 1 ) else ( Y = 1 ) \qquad Second expression$$

The above normalization rules are examples, and different normalization rules may be used as long as synonymous conditions and synonymous side effects are individually expressed in a unified description.

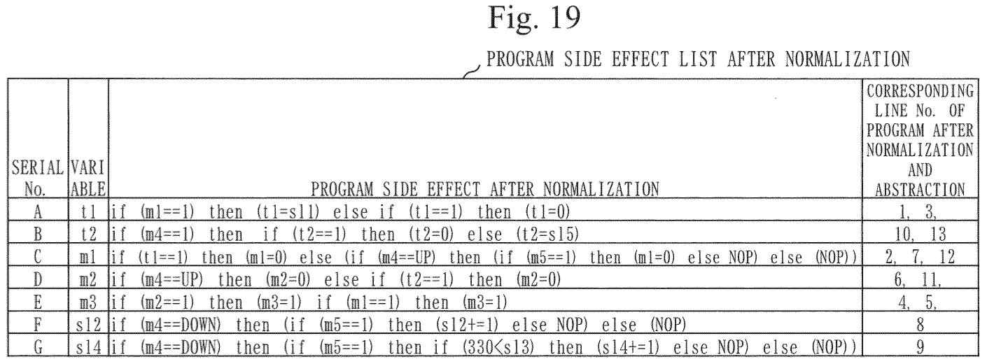

An example of side effects after normalization is illustrated in FIG. 19. In the program side effect list after normalization illustrated in FIG. 19, as a result of normalizing the program side effects in the program side effect list, the conditional statement for t2 is replaced without an inequality. Also, the direction of the inequality in the conditional statement for sl4 is reversed.

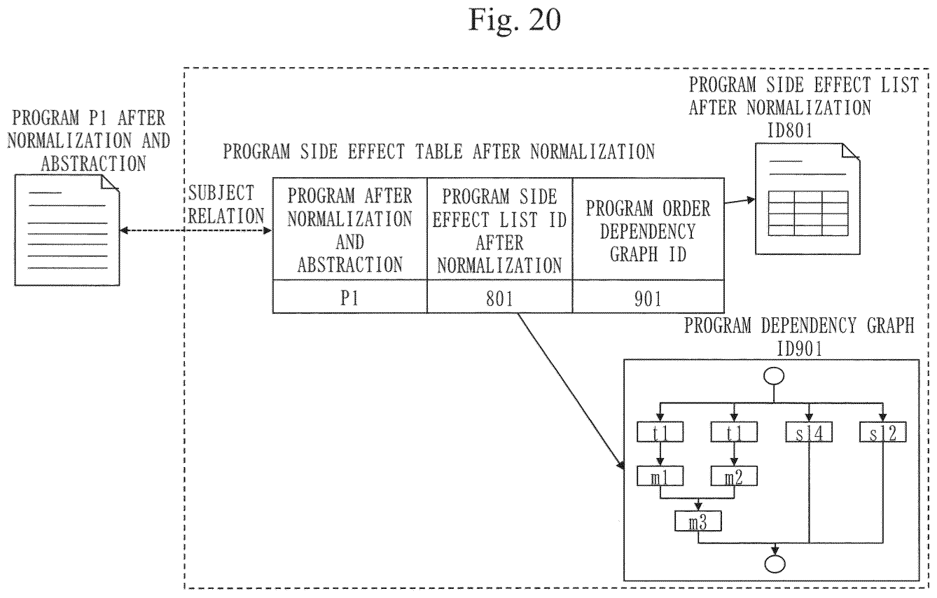

By the above, the information obtained by the program analysis unit 1041 is organized as illustrated in FIG. 20.

The program analysis unit 1041 creates one program after normalization and abstraction, and one program side effect table after normalization for each control program P. From one program side effect table after normalization, one program side effect list after normalization and one program side effect dependency graph are referred to.

The fragment side effect list after normalization of the control program P and the program side effect dependency graph of the control program P together are referred to as program side effect order constraint information.

### The Fragment Side Effect List and the Fragment Side Effect Dependency Graph of the Program Fragment Database 1043

The fragment side effect list and the fragment side effect dependency graph registered in the program fragment database 1043 can be created by the program analysis unit 1041 by analyzing the program fragment F instead of the control program P.

Specifically, the program analysis unit 1041 creates the following from the program fragment F.

Program list that textualizes the program fragment F.

Variable abstraction table of the program fragment F.

Program after normalization and abstraction of the program fragment F.

Side effect subject substitute variable table of the program fragment F.

Fragment side effect list of the program fragment F.

Fragment side effect dependency table of fragment side effects of the program fragment F.

Fragment side effect dependency graph of the program fragment F.

Fragment side effect list after normalization of the program fragment F.

The description formats of the tables, lists and graphs of these program fragments F are the same as those of the tables, lists and graphs of the control program P. Specifically, the description formats of the fragment side effect list and the program side effect list are the same. Additionally, the description formats of the fragment side effect dependency graph and the program side effect dependency graph are the same.

The fragment side effect list after normalization of the program fragment F and the fragment side effect dependency graph of the program fragment F are collectively referred to as fragment side effect order constraint information. The program analysis unit 1041 creates multiple pieces of fragment side effect order constraint information from multiple program fragments F.

### Similarity Search Unit 1042

The similarity search unit 1042 searches whether a similar program fragment with equivalent side effects to the program fragment F in the program fragment database 1043 is included in the control program P of the program memory unit 103.

The similarity search unit 1042 inputs the control program P to be searched in, created by the developer, and the program fragment F to search for, registered in the program fragment database 1043.

The similarity search unit 1042 performs a similarity search using the program side effect order constraint information (program side effect list after normalization and program order constraint information) and the fragment side effect order constraint information (fragment side effect list after normalization and fragment side effect dependency graph of program fragment F) on the side effects obtained by the program analysis unit 1041.

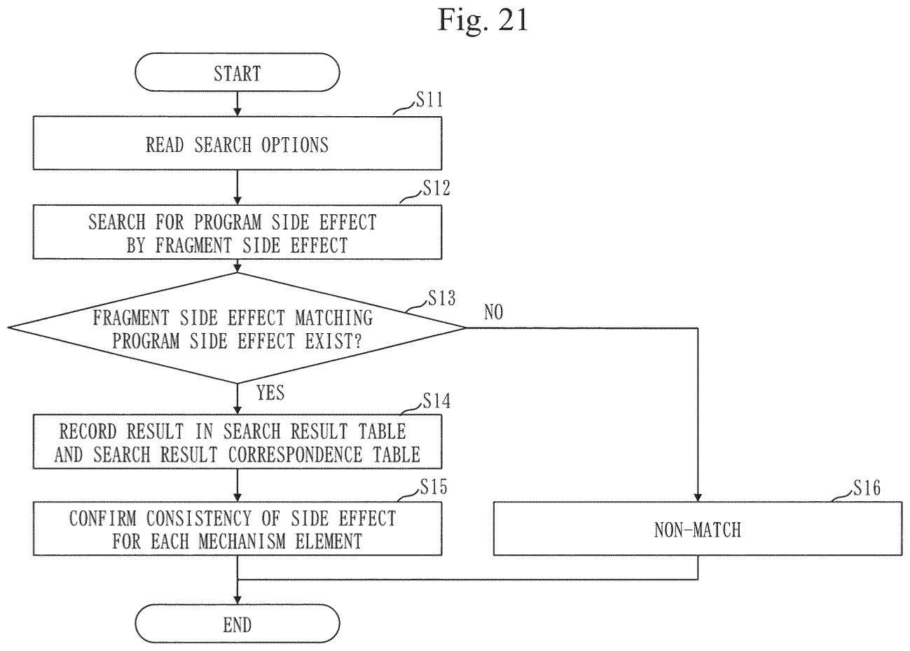

FIG. 21 illustrates the flow of operation of the similarity search unit 1042.

### Step S11: Reading Search Options

The similarity search unit 1042 reads search options, which defines looseness of the matching conditions in search, from the memory unit 92.

The reason for using the search options is supposed to expand the range decided as a match by the similarity search unit 1042 in a case in which the control program P to be searched in is created with complex control logic, and a match cannot be sufficiently decided in the similarity search.

The search options are set in the memory unit 92 by the developer using the display and operation unit 102 of the program development support device, or the similarity search unit 1042 may change the option settings in the memory unit 92 according to the search results. Specifically, as the result of search, if the number of matching search results is too large, the search options are set to tighten the matching conditions, and conversely, if the number of search results is too small, the opposite setting is considered to be made.

The following are considered for search options.
Search option 1: Whether a complete match of the order constraints of side effects is required.

If the control program P to be searched in includes all the side effects of the program fragment F to search for but does not satisfy the order constraints, the side effects may not occur successively in a single basic processing cycle, and the same side effects may be obtained after executing multiple basic processing cycles. In other words, by performing partial match search of the order constraints of side effects, it may be possible to search for many similar program fragments that yield the same side effects.

Here, the search option 1 is set to require a complete match of the order constraints of side effects.
Search option 2: Whether to allow differences in the type of substitute variables.

In the control program P, the same operation can be performed also with variables of a type with a wider range of values. Specifically, a 16-bit integer-type operation can also be performed by using 32-bit integer type. By allowing differences in the type to variables of a type with a wider range of values, it may be possible to search for many similar program fragments that can yield the same side effects.

Here, the search option 2 is set not to allow differences in the type of substitute variables.

### Step S12: Searching Program Side Effects by Fragment Side Effects

The similarity search unit 1042 confirms whether there are any matches in the program side effects with respect to all of a plurality of fragment side effects after normalization of each program fragment F of a plurality of program fragments F indicated in the fragment side effect list of the program fragment database 1043.

The similarity search unit 1042 determines a program fragment F corresponding to the fragment side effect list as a similar program fragment if all the plurality of fragment side effects after normalization in the fragment side effect list are included in the program side effect list.

In other words, the similarity search unit 1042 confirms whether the control program P satisfies all the plurality of side effects of mechanism elements for each mechanism element registered in the program fragment database 1043. If all the side effects are satisfied, it is determined that the mechanism element is included in the control program P. If there is any unsatisfied side effect, it is determined that the mechanism element is not included in the control program P.

At the stage of Step S12, only the presence or absence of matching side effects is considered, and whether the multiple matching side effects are consistent with each other is not considered. Whether the multiple matching side effects are consistent with each other is determined by the mechanism element estimation unit 1044.

The criteria for determining the match of side effects are as follows:
(a) the structure and conditions of the conditional branches of the side effects are the same; and
(b) the results of the side effects are the same; and
(c) there is no contradiction in the substitute variables related to the side effects.

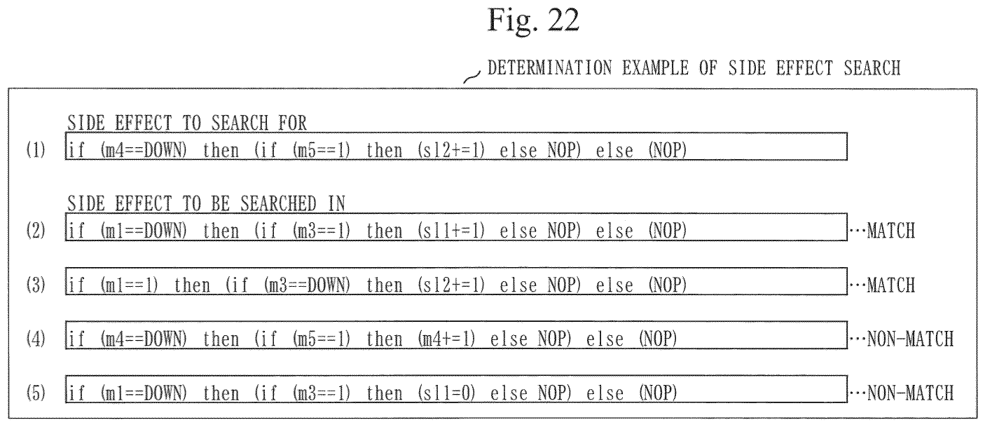

An example of match determination is illustrated in FIG. 22.

Assume that the plurality of fragment side effects after normalization (side effects to search for) with respect to the program fragment F are (1), and the program side effects (side effects to be searched in) are (2) to (5).

(2) has a different substitute variable from (1); however, by swapping m1 with m4, and m3 with m5 in (2), the structure and conditions of the conditional branches become the same conditions as (1), thus satisfying the above (a). By swapping sl1 with sl2, the same side effect sl2+=1 occurs; therefore, the result of the side effects is the same, and the above (b) is satisfied. sl1 in (1) and sl2 in (3) have the same type and no contradiction in the substitute variables, satisfying the above (c).

As a result, (2) is determined to match (1).

(3) has a different description order of branch statements compared to (1); however, by swapping m1 with m5, and m3 with m4, the structure and conditions of the conditional branches become the same as those in (1), thus satisfying the above (a). Since the same side effect sl2+=1 occurs, the result of the side effect is the same, satisfying the above (b). sl2 in (1) and sl2 in (3) have the same type and no contradiction in the substitute variables, satisfying the above (c).

As a result, (3) is determined to match (1).

As for (4), no matter how the variables are swapped, the substitute variable sl2 of the side effect is different in type from the substitute variable m4 in (1), and there is contradiction in the substitute variables; therefore, (4) is contrary to the above (c), and is determined to be a non-match with (1).

As for (5), the result of the side effect on sl1 (sl1=0) is different from the result of the side effect on sl2 in (1) (sl2+=1); therefore, (5) is contrary to the above (b), and is determined to be a non-match with (1).

Next, the similarity search unit 1042 determines whether the order dependency of fragment side effects satisfies the order dependency of program side effects with respect to a program fragment F where all fragment side effects match the program side effects. Specifically, the similarity search unit 1042 compares the program order constraint information (program order dependency graph) with the fragment order constraint information (fragment order dependency graph) to check if the dependencies of the side effect subject substitute variables match. If the dependencies of the side effect subject substitute variables match, the similarity search unit 1042 determines that there is equivalence between the program side effects and the fragment side effects.

Step S13: There is a Fragment Side Effect that Matches the Program Side Effect

The similarity search unit 1042 transitions to Step S14 if it determines that all the plurality of fragment side effects after normalization in the fragment side effect list are included in the program side effects in the program side effect list, and that there is at least one fragment side effect list where the dependencies of the side effects match. Otherwise, the similarity search unit 1042 transitions to Step S16. In other words, if the similarity search unit 1042 determines that there exists at least one similar program fragment, it transitions to Step S14, and otherwise, it transitions to Step S16.

### Step S14: Record the Results

The similarity search unit 1042 records in a search result table the presence or absence of a match with respect to program fragments F (mechanism elements) corresponding to the fragment side effect list.

The similarity search unit 1042 estimates a program fragment F (mechanism element) corresponding to the fragment side effect list, where all of the plurality of fragment side effects after normalization in the fragment side effect list are included in the program side effects, and the dependencies of the side effects match, as a similar program fragment included in the control program P.

The similarity search unit 1042 records in a search result correspondence table the correspondence relation of the similar program fragment F (mechanism element) with lines of the program after normalization and abstraction.

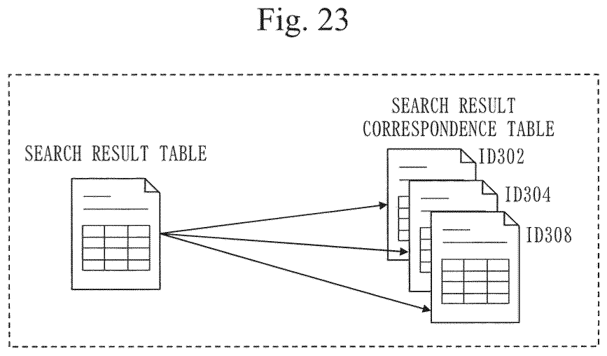

The relation between the search result table and the search result correspondence tables is as illustrated in FIG. 23, where the search result correspondence tables are referred to from the search result table.

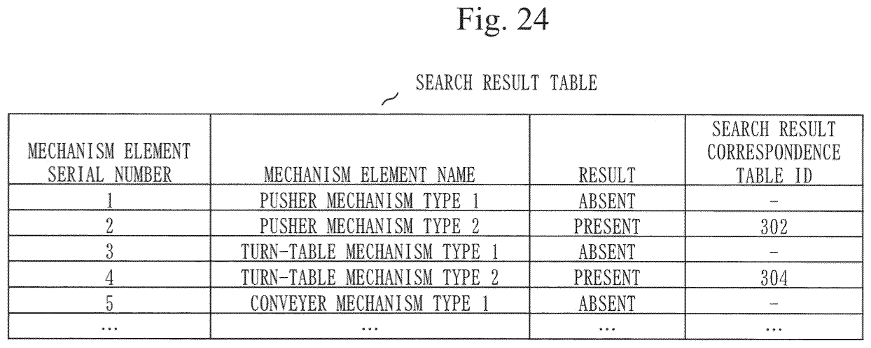

An example of the search result table is illustrated in FIG. 24.

Each row of the search result table corresponds to a mechanism element described in the mechanism element side effect table registered in the program fragment database 1043. The result column indicates whether the program fragment F being the relevant mechanism element is included in the control program P. If the result is “present,” an search result correspondence table ID for identifying the corresponding search result correspondence table is recorded.

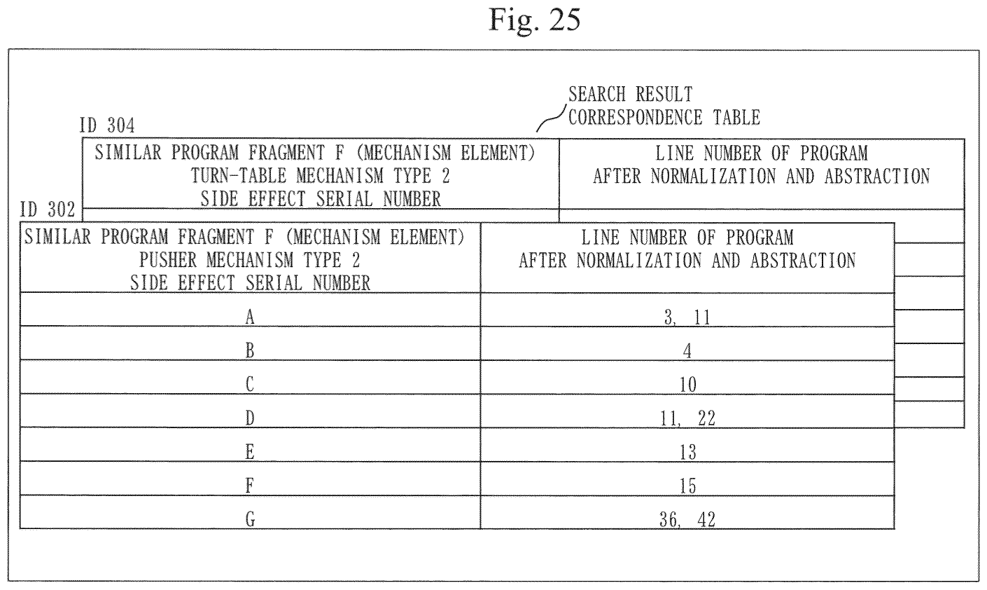

An example of the search result correspondence table is illustrated in FIG. 25.

Each row of the search result correspondence table corresponds to a side effect of the program fragment F being the mechanism element in the program fragment database 1043. The “line number of the program after normalization and abstraction” lists one or more line numbers of the control program P (program after normalization and abstraction) that are determined to match the said side effect.

### Step S15: Confirm Consistency of Side Effects for Each Mechanism Element

When there are multiple corresponding lines of the control program P after normalization and abstraction with respect to one side effect in the search result correspondence table, the similarity search unit 1042 creates a side effect consistency table to confirm which combination of lines can realize the said mechanism element.

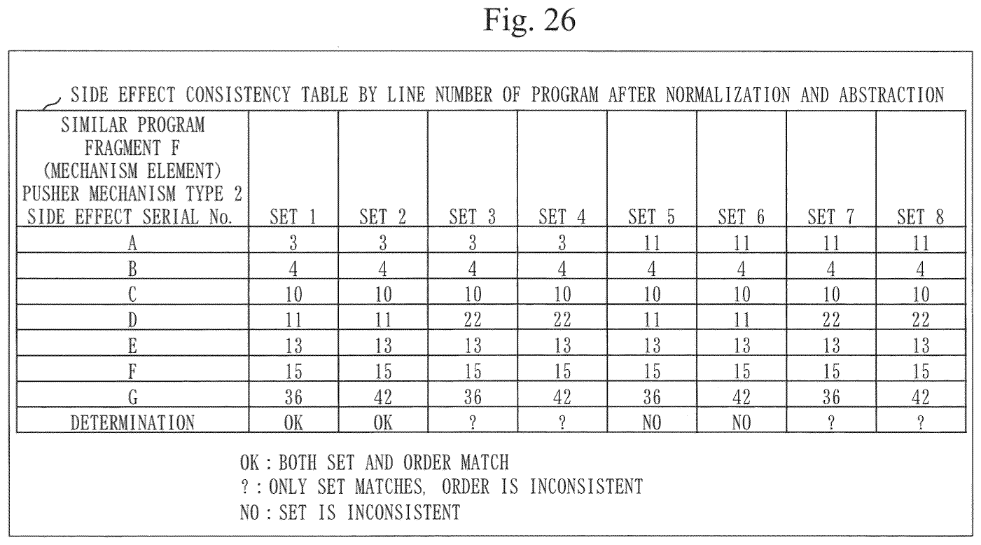

An example of the side effect consistency table is illustrated in FIG. 26.

One side effect consistency table is created for the mechanism element determined to be included in the control program P.

Each row of the side effect consistency table corresponds to a side effect of the program fragment F being the said mechanism element in the program fragment database 1043.

The similarity search unit 1042 creates one or more sets of line numbers (line number sets) that associate multiple fragment side effects of the program fragment F with each line number of one or more line numbers of the program list in a one-to-one correspondence.

As per the search result correspondence table, there are eight line number sets of the program after normalization and abstraction that realize each side effect. Each column of the side effect consistency table enumerates all these eight sets.

Among the eight sets, those with duplicate line numbers in the program after normalization and abstraction indicate “NO” in the determination column as inconsistency in order to express that the processing to realize the said side effect is not included in the control program.

Furthermore, for those with line numbers in the program after normalization and abstraction corresponding to the side effects of the program fragment F being the mechanism element that are not in ascending order, “?” is indicated since there is a possibility that the side effects of the control program P are not realized in the order of the side effects of the program fragment F.

Finally, for those without duplicate line numbers in the program after normalization and abstraction, and with line numbers in the program after normalization and abstraction in ascending order, “OK” is indicated.

The similarity search unit 1042 considers that there is a consistent line number set when there is a line number set where all of the plurality of fragment side effects of the line number set correspond to program side effects obtained from different lines of the program list of the control program. In other words, the similarity search unit 1042 considers a line number set to be consistent if all line numbers in the line number set are different. The similarity search unit 1042 considers a program fragment F corresponding to a fragment side effect list with one or more consistent line number sets as a similar program fragment.

At the stage of Step S15, in accordance with the settings of the search options, a set where the order constraints of side effects completely match is marked “OK”, and a set where the order constraints of side effects do not match completely is marked “?”.

The similarity search unit 1042 obtains the following tables and ends the processing.
Search result table
Search result correspondence table
Side effect consistency table based on line numbers of the program after normalization and abstraction

### Step S16: No Match

The processing of the similarity search unit 1042 ends when it is determined that there is no match in the search results. If it is determined that there is no match, the present procedure is re-executed after loosening the match conditions by changing the search options. Alternatively, if there is no room for further loosening of the search options, it is determined that there are no fragments in the control program that can be modeled.

Specific examples of changes to the search options are as follows.

### (1) Loosening of Search Option 1

The similarity search unit 1042 performs search without requiring a complete match of the order constraints of side effects. In other words, the similarity search unit 1042 performs search only requiring a partial match of the order constraints of side effects. If it is determined that there is no match in the partial match, the similarity search unit 1042 further loosens the search option 1 and perform search by ignoring the order constraints of side effects.

### (2) Loosening of Search Option 2

The similarity search unit 1042 performs search allowing differences in the types of substitute variables.

When the similarity search unit 1042 examines criterion (c) for determining matching of side effects, it considers that there is no contradiction in the substitute variables related to side effects even if there are differences in types that are not identical but are upwardly compatible. Specifically, the similarity search unit 1042 determines that a substitute variable of a 16-bit integer type may be a substitute variable of a 32-bit integer type.

### The Mechanism Element Estimation Unit 1044

The mechanism element estimation unit 1044 estimates which combination of mechanism elements one control program P (to be searched in) controls, from among combinations of mechanism elements that may exist more than one, based on the side effect consistency table obtained from the search for the one control program P.

An example will be described.

### (1) When Two Mechanism Elements are Included

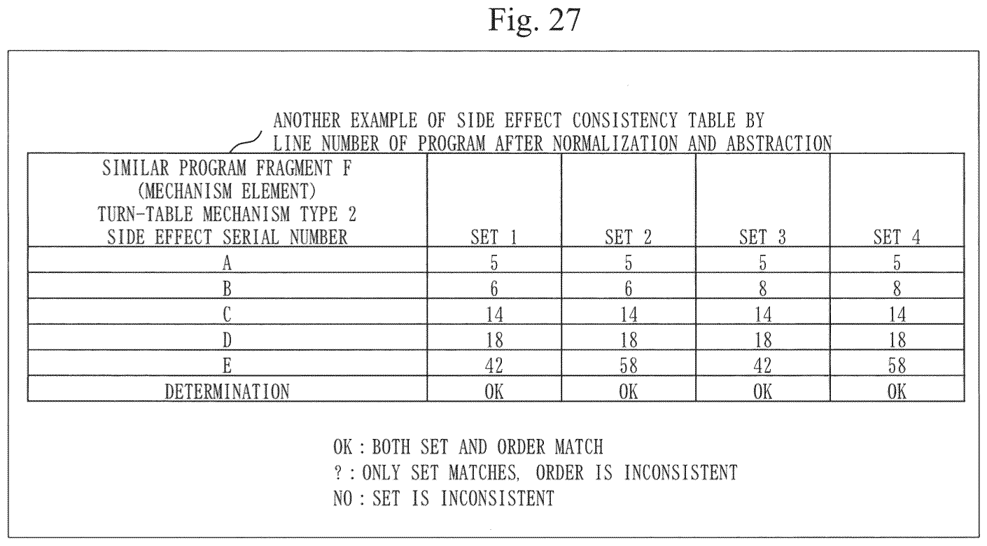

Let us assume that a search result table indicating that two mechanism elements are included is obtained as a result of search for one control program P (to be searched in) by the similarity search unit 1042. The side effect consistency table obtained for the first mechanism element shall be FIG. 26, and the side effect consistency table obtained for the second mechanism element shall be FIG. 27. At this time, if both mechanism elements correspond to lines of the control program P after normalization and abstraction without any overlap, the two mechanism elements can coexist.

If the search option is set to require a complete match of the order constraints of side effects, by using sets with determination of “OK” while excluding sets with determination of “NO” and “?” in the side effect consistency table, all combinations are generated by extracting one column each from the two side effect consistency tables, and all combinations without duplicate line numbers are extracted.

Combinations are expressed in the notation {column of the first side effect consistency table, column of the second side effect consistency table}. This list of combinations is called a side effect combination list.

If there are only sets with determination of “OK”, extracting all combinations without duplicates results in the following side effect combination list.
{Set 1, Set 1}, {Set 1, Set 2}, {Set 1, Set 3}, {Set 1, Set 4},
{Set 2, Set 2}, {Set 2, Set 4}.
{Set 2, Set 1} and {Set 2, Set 3} cannot coexist since both mechanism elements require the 42nd line of the program after normalization and abstraction.

If the search option is set not to require a complete match of the order constraints of side effects, all combinations are generated by extracting one column each from the two side effect consistency tables while excluding columns with determination of “NO” in the side effect consistency table, and all combinations without duplicate line numbers are extracted.

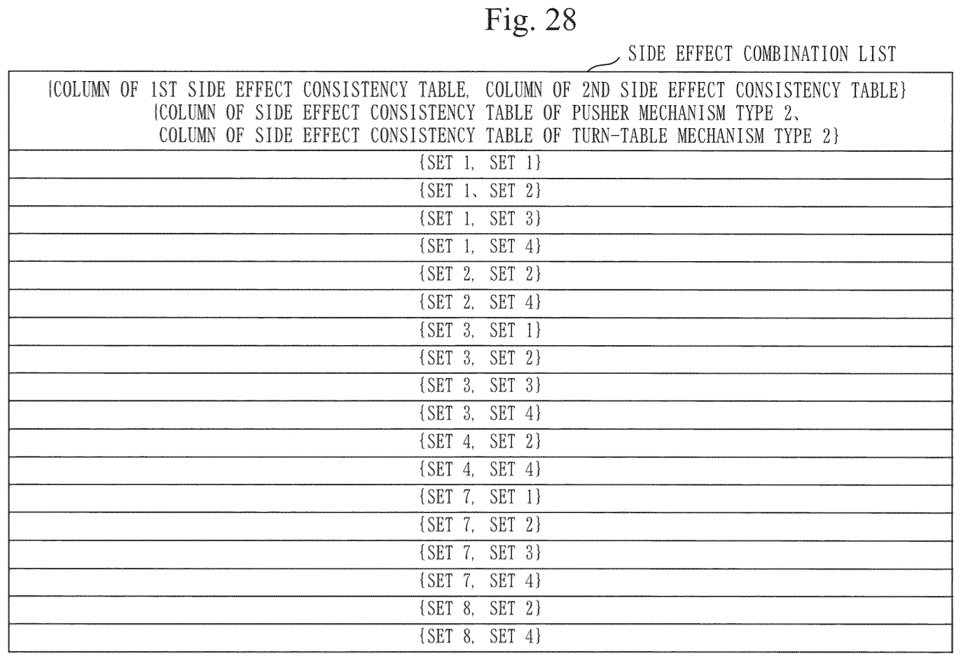

If sets with determination of “NO” are excluded, extracting all combinations without duplicates results in a side effect combination list illustrated in FIG. 28.
{Set 1, Set 1}, {Set 1, Set 2}, {Set 1, Set 3}, {Set 1, Set 4},
{Set 2, Set 2}, {Set 2, Set 4},
{Set 3, Set 1}, {Set 3, Set 2}, {Set 3, Set 3}, {Set 3, Set 4},
{Set 4, Set 2}, {Set 4, Set 4},
{Set 7, Set 1}, {Set 7, Set 2}, {Set 7, Set 3}, {Set 7, Set 4},
{Set 8, Set 2}, {Set 8, Set 4}.

The following combinations cannot coexist because both mechanism elements require the 42nd line of the program after normalization and abstraction.
{Set 2, Set 1}, {Set 2, Set 3},
{Set 4, Set 1}, {Set 4, Set 3},
{Set 8, Set 1}, {Set 8, Set 3}.

### (2) When One Mechanism Element is Included

Let us assume that only one mechanism element is included as a result of search for one control program P (target to be searched in) by the similarity search unit 1042. The side effect consistency table obtained for the first mechanism element shall be FIG. 26. Combinations are expressed in the notation {column of the first side effect consistency table}.

If the search option is set to require a complete match of the order constraints of side effects, the side effect combination list is as follows.
{Set 1},
{Set 2}.

If the search option is set not to require a complete match of the order constraints of side effects, the side effect combination list is as follows.
{Set 1},
{Set 2},
{Set 3},
{Set 4},
{Set 7},
{Set 8}.

Note that even in the case where two mechanism elements are included as in (1) described above, if all sets in the side effect consistency table obtained for one mechanism element are “NO”, the case is treated in the same way as the case where one mechanism element is included as in (2), and a side effect combination list is created using only the side effect consistency table obtained for the other mechanism element.

### (3) When Three or More Mechanism Elements are Included

As a result of search for one control program P (to be searched in) by the similarity search unit 1042, three or more mechanism elements may be included. If three or more mechanism elements correspond to lines of the control program P after normalization and abstraction without duplication, three or more mechanism elements can coexist.

If three mechanism elements can be searched, the side effect combination list is expressed in the notation {column of the first side effect consistency table, column of the second side effect consistency table, column of the third side effect consistency table}.

In this way, the side effect combination list is a list that describes one or more line number sets in each row.

The mechanism elements corresponding to the combinations indicated in the side effect combination list are mechanism elements that can be realized simultaneously.

The mechanism element estimation unit 1044 outputs the side effect combination list.

By combining the previous search result table, the side effect combination list, and the program list of the program after normalization and abstraction, it is possible to understand all combinations of which mechanism elements are likely to be realized by which rows of the program list of the program after normalization and abstraction.

It should be noted that not all rows of the program after normalization and abstraction are necessarily determined to correspond to mechanism elements comprehensively, and there may be rows for controlling mechanism elements that are not registered in the program fragment database 1043, rows for peripheral processing of control over mechanism elements, or rows for other processing that remain unassociated with mechanism elements.

### Model Database 1046

The model database 1046 registers models corresponding to the program fragments F registered in the program fragment database 1043 as mechanism element models.

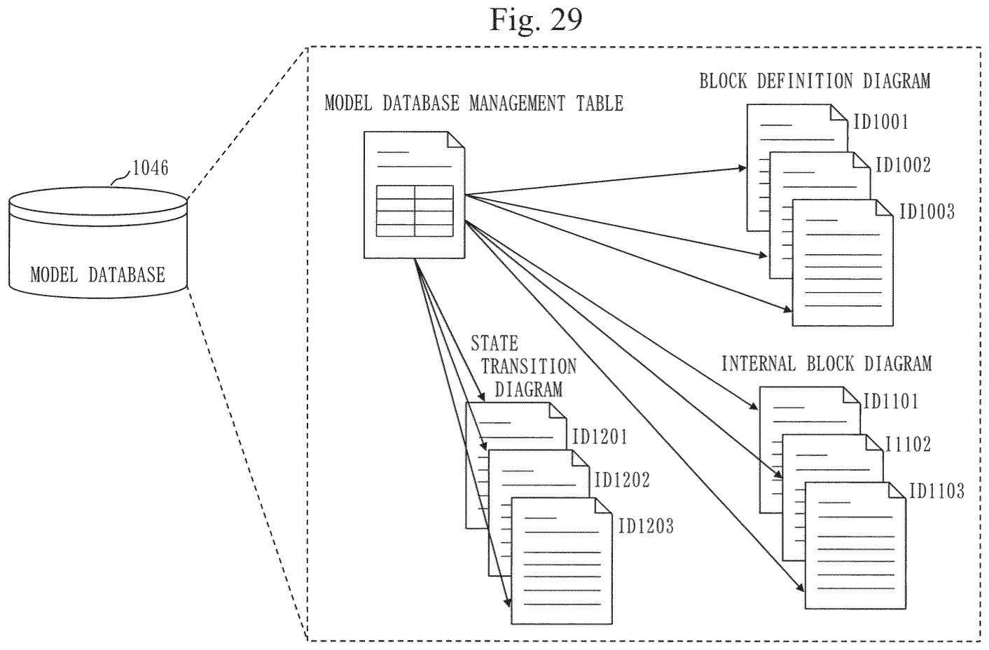

The model database 1046 has a structure illustrated in FIG. 29.

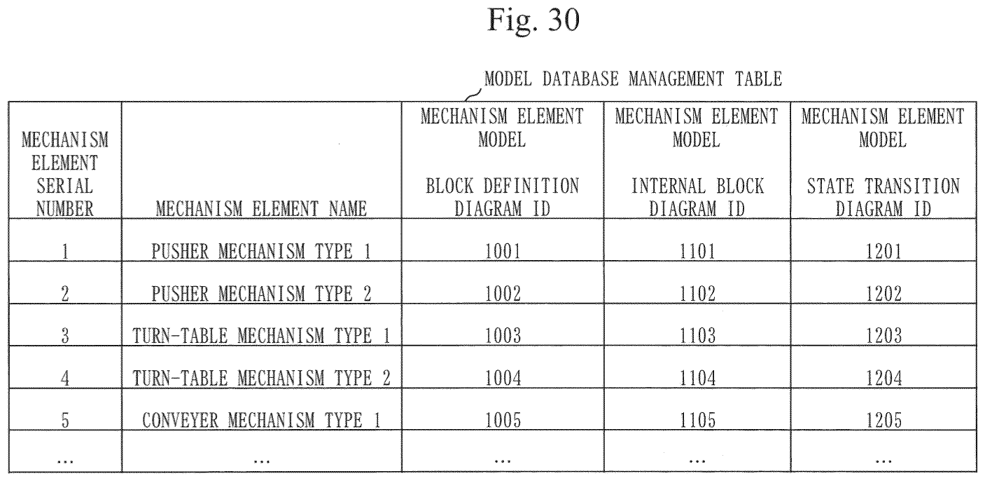

Models corresponding to mechanism element identifiers (mechanism element serial numbers) can be referred to in the model database management table in FIG. 30. The models in the present embodiment are assumed to be block definition diagrams, internal block diagrams, and state transition diagrams; however, the models are not limited to these.

The model database 1046 may be predefined as with the program fragment database 1043, or developers may have means to register, edit and delete the model database 1046. In either case, the generation of models to be registered requires manual creation by a person (developer of the program development support device). However, since models for multiple program fragments F can be considered beforehand, there is less complexity in generating models than in generating models from an entire large-scale control program. Furthermore, contents of the models can be defined based on the behaviors of mechanism elements described in the books mentioned above, making realization of model generation possible.

### Model Configuration Unit 1045

The model configuration unit 1045 retrieves a corresponding mechanism element model from the model database 1046 for each of a plurality of combinations in the side effect combination list.

The model configuration unit 1045 displays on the monitor via the display and operation unit 102 the connection relations of interfaces between mechanism element models with following information being added:
Variables and output port names of the control program P corresponding to the interfaces of mechanism element models.
Row numbers in the control program P corresponding to the mechanism element models.

Basically, it is expected that the model configuration unit 1045 retrieves all mechanism elements whereof the results become “present” in the search result table; however, it may be possible that all mechanism elements are not realized simultaneously depending on the side effect combination list. In such cases, the model configuration unit 1045 retrieves mechanism element models by narrowing down the mechanism elements to only the mechanism elements that can be realized simultaneously as described in the combinations in the side effect combination list.

The model configuration unit 1045 refers to the side effect consistency table, the search result correspondence table and the search result table in the side effect combination list to retrieve mechanism element models, and identifies the mechanism element serial numbers.

The model configuration unit 1045 uses the model database management table to retrieve various models corresponding to the mechanism element serial numbers.

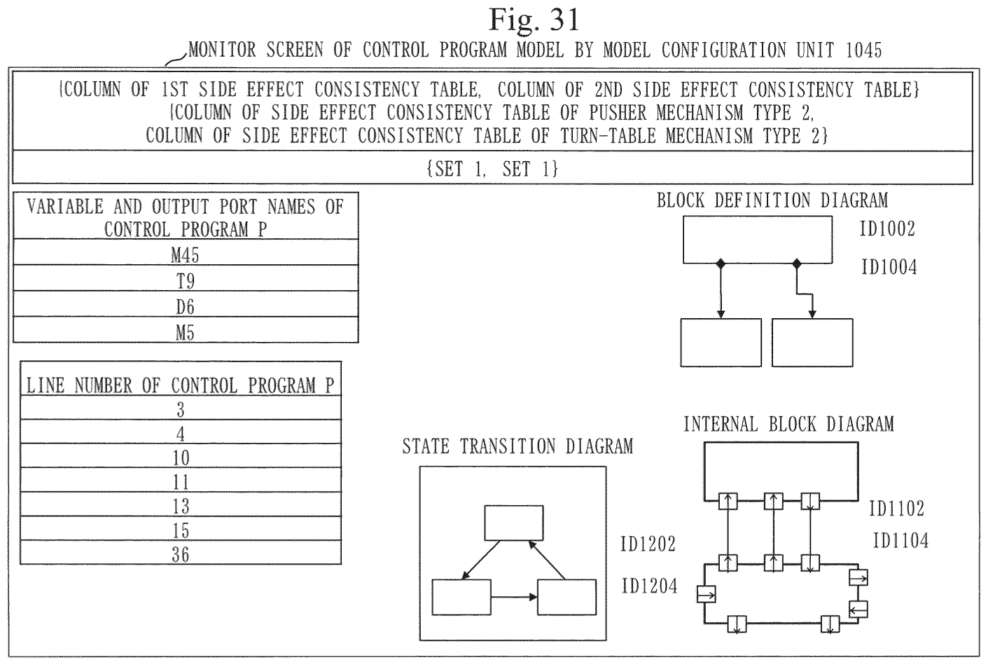

FIG. 31 illustrates a display example of the monitor in a case of {Set 1, Set 1}.

On the monitor, a state transition diagram, a block definition diagram, and an internal block diagram of a pusher mechanism type 2, and a state transition diagram, a block definition diagram and an internal block diagram of a turntable mechanism type 2 are combined, and a control program model of the state transition diagrams, the block definition diagrams and the internal block diagrams is described.

The identification of connection relations between multiple mechanism elements is performed for block definition diagrams and internal block diagrams.

The mechanism element models in the model database 1046 record substitute variables appearing in side effects and input and output interfaces of the models in an associated manner. As a result, if the interfaces between mechanism element models are connected, those mechanism element models are wired together and displayed as a control program model with the connection relations added.

The connection relations of mechanism elements or models may vary depending on which combination in the side effect combination list is used for display. Some combinations in the side effect combination list may correctly represent the models of actual production equipment, while others may not. To select correctly represented models, the display and operation unit 102 provides a function for developers to select combinations in the side effect combination list, and the model configuration unit 1045 configures models according to the selection.

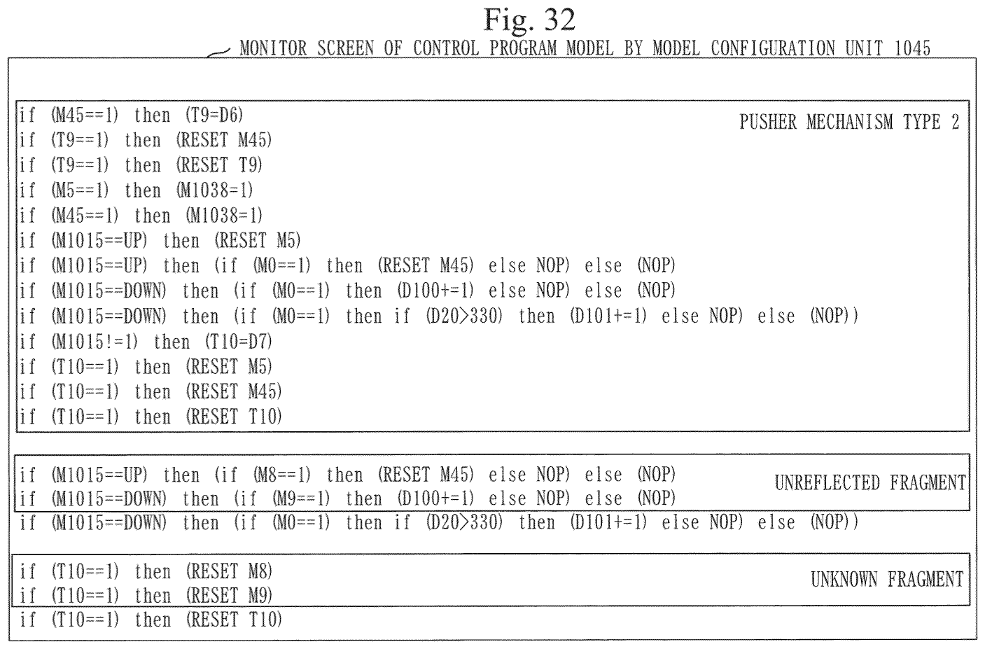

As illustrated in FIG. 32, the model configuration unit 1045 displays on the monitor via the display and operation unit 102 any fragments in the control program P that have not been used in configuration of the control program model as fragments that are not reflected on the control program model, leaving room for developers to interpret the fragments separately.

The model configuration unit 1045 also displays on the monitor via the display and operation unit 102 any parts that are not identified due to insufficient information or inconsistency in the connection relations between mechanism element models as unknown fragments.

The model configuration unit 1045 indicates information that cannot be concluded with blanks in the control program model as well, allowing for input by the user afterwards via the display and operation unit 102.

As described above, in First Embodiment, a standard control program for each mechanism element is databased as program fragments F, and by searching for fragments similar to the program fragments F in the control program P, the program fragments F are detected from the database.

The similarity search is realized by extracting as “side effects” how the control program P causes change to external variables as a result of execution of the control program P, and by comparing their equivalence.

By associating and databasing the program fragments F with their mechanism element models, and retrieving and combining corresponding mechanism element models based on the results of the similarity search, conversion from the control program P to a control program model is performed.

According to the above, it is possible to generate a control program model from the control program P.

### Summary of First Embodiment

The program development support device 1 includes the program analysis unit 1041 and the similarity search unit 1042.

The program fragment database 1043 registers a list of multiple fragment side effects, which indicates multiple side effects included in a program fragment F corresponding to a mechanism element as multiple fragment side effects, by associating the list of multiple fragment side effects with multiple program fragments F.

The program fragment database 1043 registers the order constraints of multiple fragment side effects included in the program fragment F corresponding to the mechanism element as multiple pieces of fragment order constraint information by associating the order constraints with multiple program fragments F.

The program analysis unit 1041 analyzes the control program, and creates a program side effect list that indicates multiple side effects included in the control program as multiple program side effects.

The program analysis unit 1041 creates the order constraints of the multiple program side effects as program order constraint information.

The similarity search unit 1042 compares the multiple program side effects indicated in the program side effect list with the multiple fragment side effects indicated in the list of multiple fragment side effects, and searches for a program fragment F corresponding to a fragment side effect list where the multiple fragment side effects are included in the multiple program side effects, as a similar program fragment.

The similarity search unit 1042 compares the order constraints in the program order constraint information with the order constraints in multiple pieces of fragment order constraint information, and considers a program fragment F that corresponds to fragment order constraint information where the order constraints in the fragment order constraint information are included in the order constraints in the program order constraint information, as a similar program fragment.

Based on the setting of search options, the similarity search unit 1042 considers a program fragment F, where the order constraints in the fragment order constraint information do not completely match the order constraints in the program order constraint information among the program fragments F searched for, as a similar program fragment that yields the same side effects through multiple basic processing cycles.

The program analysis unit 1041 performs normalization that restricts the description of the program list of the control program, and abstraction that replaces the variables in the program list of the control program with substitute variables, and the program analysis unit 1041 normalizes the program side effects by expressing synonymous conditions in a unified description, and synonymous side effects in a unified description for description of the multiple program side effects indicated in the program side effect list.

The similarity search unit determines that a fragment side effect matches a program side effect by using the following determination criteria:
(a) the structure and conditions of conditional branches of side effects are the same; and
(b) the results of the side effects are the same; and
(c) there are no contradictions in the substitute variables related to the side effects.

The program fragment database 1043 registers the variables used by each of the multiple program fragments F and the variables referred to by those variables as multiple pieces of fragment order constraint information.

The program analysis unit 1041 creates the variables used by the control program and the variables referred to by those variables as program order constraint information.

The similarity search unit 1042 considers a program fragment F that corresponds to fragment order constraint information as a similar program fragment when the order constraints indicated in each of the multiple pieces of fragment order constraint information match the order constraints indicated in the program order constraint information.

The program analysis unit 1041 detects the variables whose values are changed by side effects and one or more line numbers in which the values of the variables are changed for each line of the program list of the control program.

The program analysis unit 1041 creates a list that associates variables, side effects and one or more line numbers, as a program side effect list.

The similarity search unit 1042 creates one or more line number sets that associate the multiple fragment side effects of the program fragment F with each line number of one or more line numbers of the program list in a one-to-one correspondence.

The similarity search unit 1042 considers a program fragment F that corresponds to a fragment side effect list as a similar program fragment if there is a line number set among the one or more line number sets where all the multiple fragment side effects correspond to program side effects obtained from different lines of the program list of the control program, indicating that there is one or more consistent line number sets.

The program development support device 1 includes the mechanism element estimation unit 1044, the model database 1046 and the model configuration unit 1045.

The mechanism element estimation unit 1044 determines whether different lines of the control program correspond to all the multiple fragment side effects included in multiple similar program fragments when the similarity search unit 1042 searches for the multiple similar program fragments.

The mechanism element estimation unit 1044 estimates the combination of mechanism elements corresponding to the multiple similar program fragments as a consistent combination of mechanism elements if different lines of the control program correspond to all the multiple fragment side effects.

The mechanism element estimation unit 1044 creates a side effect combination list by combining each line number set of one or more consistent line number sets of the multiple similar program fragments searched by the similarity search unit 1042.

The mechanism element estimation unit 1044 estimates the combination of mechanism elements corresponding to the multiple similar program fragments as a consistent combination of mechanism elements when the lines described in the multiple line number sets of each combination in the side effect combination list correspond to different lines of the control program.

The model database 1046 stores multiple mechanism element models corresponding to each of the multiple program fragments F.

The model database 1046 includes at least any of a block configuration diagram, an internal block diagram and a state transition diagram, as a mechanism element model.

The model configuration unit 1045 retrieves multiple models corresponding to multiple program fragments F described in the consistent combination of mechanism elements from the model database 1046, and combines the multiple models to construct a control program model of the control program.

The program analysis unit 1041 creates a program side effect list from the control program using the same processing as the processing used to create the list of multiple fragment side effects from each of the multiple program fragments.

The program analysis unit 1041 creates program order constraint information from the control program using the same processing as the processing used to create the multiple pieces of fragment order constraint information from each of the multiple program fragments.

The program development support device is characterized by searching for and displaying program fragments F from the control program where the variables or the results to ports after execution thereof are equivalent.

The program development support device is characterized by generating a control program model that abstractly expresses the target to be controlled by the control program, by taking the control program as input.

The program development support device is characterized by being able to search for fragments from the control program that yield the same side effects through multiple basic processing cycles by determining fragments that include all the same side effects as the program fragment F but the order constraints do not completely match as a match, through option settings in the similarity search.

The program development support device includes the following:
the program memory unit 103 that stores the control program;
the program analysis unit 1041 that extracts side effects, which are changes in variables or port values after execution of the control program, from the control program, and extracts a program side effect list after normalization and abstraction by performing normalization and abstraction, and program order constraint information representing the order relations of side effects to ensure the equivalence of the side effects;
the program fragment database 1043 that registers multiple program fragments F, multiple side effect lists after normalization and abstraction, and multiple pieces of order constraint information;
the similarity search unit 1042 that compares the side effect list and order constraint information after normalization and abstraction of the control program with the side effect list and order constraint information after normalization and abstraction of the program fragment F;
the mechanism element estimation unit 1044 that estimates elements such as mechanical mechanisms or electrical circuits controlled by the control program;
the model database 1046 that stores models corresponding to program fragments stored in the program fragment database 1043; and
the model configuration unit 1045 that constructs a control program model by obtaining mechanism element models corresponding to the mechanical mechanisms or electrical circuits controlled by the control program from the model database, and specifying the connection relations of interfaces between the mechanism element models.

### Description of Effects of First Embodiment

According to the present embodiment, the similarity search is performed for the behavior of the program fragment F in the control program P using the program fragment database 1043, which stores standard program fragments F, and the program analysis unit 1041, which extracts side effects representing the behavior and their order constraints from control program P. This allows for the identification of mechanism elements controlled by the control program P.

Additionally, by allowing the degree of match of order constraints to be selectable, it is possible to perform the similarity search for fragments of the control program that require multiple basic processing cycles but exhibit the same behavior, enabling the modeling of the control program.

According to the present embodiment, it is possible to derive a control program model to be used in model database development based on the control program P of production equipment. In this process, even for a control program P that is not implemented based on common protocols and has inconsistent syntax, etc., it is possible to derive a control program model based on the behavior.

According to the present embodiment, it is easy to implement model database development utilizing development assets of the existing control program P. If model database development can be implemented, it is possible to repurpose existing assets for similar development by reinterpreting the existing assets at a higher level of abstraction, thereby streamlining control program development through reduction of development man-hours and prevention of defect introduction.

Additionally, as an auxiliary effect of the present embodiment, even when application to model database development is not performed, the diversion development of the control program P can be streamlined. As described above, when a third party different from the developers conducts the diversion development of control program P, it is difficult to identify the parts to be changed and the impact of those changes due to insufficient understanding of the structure or design philosophy of the control program P to be repurposed compared to the developers themselves. In contrast, if the control program P can be converted into a control program model, understanding of the structure and design philosophy progresses in a top-down approach, thereby streamlining the diversion development.

Furthermore, by using part of the functions of the present embodiment, it is also possible to find similar program fragments F (so-called code clones) in the control program. In this manner, frequently occurring processing in the control program can be made into a library and refactoring functions can be realized.

### Description of Other Configurations of First Embodiment

### Modification Example 1: Program Order Constraint Information and Fragment Order Constraint Information

As program order constraint information, a program side effect dependency table may be used instead of the program side effect dependency graph.

The program order constraint information can be in any notation as long as the order constraints of the program side effects are understood.

As the fragment order constraint information, a fragment side effect dependency table may be used instead of the fragment side effect dependency graph.

The fragment order constraint information can be in any notation as long as the order constraints of the fragment side effects are understood.

### Modification Example 2: Program Fragment F

As a program fragment F, a part of the control program P may be registered in the program fragment database 1043.

As a program fragment F, a fragment similar to the program fragment F of the control program P may be registered in the program fragment database 1043.

As a program fragment F, fragment side effect order constraint information obtained by analyzing the program fragment F with the program analysis unit 1041 may be stored.

### Modification Example 3: Creation of Fragment Side Effect List and Fragment Side Effect Dependency Graph

The fragment side effect list and the fragment side effect dependency graph in the program fragment database 1043 do not necessarily have to be created by the program analysis unit 1041, and may be created by other means or manually.

The fragment side effect list and the fragment side effect dependency graph may be a mix of those created by the program analysis unit 1041, those created by other means, or those created manually.

### Modification Example 4: Description Format of Fragment Side Effect List and Fragment Side Effect Dependency Graph

The description formats of the tables, the lists and the graphs of the program fragments F do not have to be the same as those of the tables, the lists and the graphs of the control program P, as long as both can be compared by the similarity search unit 1042. Specifically, the fragment side effect dependency table of the program fragment F and the program side effect dependency graph of the control program may be compared.

### Modification Example 5

The similarity search unit 1042 may search for program fragments where not all the multiple fragment side effects completely match but mostly match the program side effects with respect to the program fragment F. Since there may be a case in which not all the multiple fragment side effects are essential side effects for the program fragment F, the similarity search unit 1042 may search for the program fragments where most of the multiple fragment side effects match the program side effects.

Specifically, by setting options, the matching ratio of the multiple fragment side effects to the program side effects can be set to 100% match, 90% match, 80% match, and so on.

### REFERENCE SIGNS LIST

1: program development support device; 2: bus for setting; 3: controller; 4: proximity device; 5: remote device; 6: control network; 9: engineering workstation; 91: CPU; 92: memory unit; 93: non-volatile memory unit; 94: configuration port; 95: bus; 101: programming unit; 102: display and operation unit; 103: program memory unit; 104: model extraction unit; 105: program setting and storing unit; 1041: program analysis unit; 1042: similarity search unit; 1043: program fragment database; 1044: mechanism element estimation unit; 1045: model configuration unit; 1046: model database; F: program fragment; P: control program.

1. A program development support device comprising:
a program fragment database to register a list of a plurality of fragment side effects indicating a plurality of side effects that are included in a program fragment corresponding to a mechanism element, as a plurality of fragment side effects, by associating the list of the plurality of fragment side effects with a plurality of program fragments; and
processing circuitry
to analyze a control program, and to create a program side effect list indicating a plurality of side effects that are included in the control program as a plurality of program side effects; and
to compare the plurality of program side effects indicated in the program side effect list with the plurality of fragment side effects indicated in the list of the plurality of fragment side effects, and to search for a program fragment corresponding to a fragment side effect list where the plurality of fragment side effects are included in the plurality of program side effects, as a similar program fragment.

2. The program development support device as defined in claim 1, wherein the program fragment database registers an order constraint of the plurality of fragment side effects as a plurality of pieces of fragment order constraint information by associating the order constraint with the plurality of program fragments,
the processing circuitry creates an order constraint of the plurality of program side effects as program order constraint information, and
the processing circuitry compares the order constraint of the program order constraint information with the order constraint of the plurality of pieces of fragment order constraint information, and considers a program fragment corresponding to fragment order constraint information where the order constraint of the fragment order constraint information is included in the order constraint of the program order constraint information, as the similar program fragment.

3. The program development support device as defined in claim 2, wherein the processing circuitry considers a program fragment where the order constraint of the fragment order constraint information does not completely match the order constraint of the program order constraint information, as the similar program fragment that can yield a same side effect through a plurality of basic processing cycles, based on a setting of a search option.

4. The program development support device as defined in claim 1, further comprising a the processing circuitry to estimate, when the processing circuitry searches for a plurality of similar program fragments, a combination of mechanism elements corresponding to the plurality of similar program fragments where all of the plurality of fragment side effects that are included in the plurality of similar program fragments correspond to different lines of the control program, as a combination of consistent mechanism elements.

5. The program development support device as defined in claim 4, further comprising:
a model database to store a plurality of mechanism element models corresponding to each of the plurality of program fragments, and
the processing circuitry retrieves a plurality of models corresponding to the plurality of program fragments that are indicated in the combination of consistent mechanism elements from the model database, and to construct a control program model of the control program by combining the plurality of models.

6. The program development support device as defined in claim 1, wherein the processing circuitry performs normalization to restrict a description of a program list of the control program, and abstraction to replace a variable of the program list of the control program with a substitute variable, and
the processing circuitry normalizes a program side effect by expressing a synonymous condition in a unified description, and a synonymous side effect in a unified description with respect to a description of the plurality of program side effects that are indicated in the program side effect list.

7. The program development support device as defined in claim 1, wherein the processing circuitry determines that a fragment side effect matches a program side effect by using:
(a) a structure and a condition of a conditional branch of a side effect is the same;
(b) a result of the side effect is the same; and
(c) there is no contradiction in a substitute variable related to the side effect, as determination criteria.

8. The program development support device as defined in claim 2, wherein the program fragment database registers a variable used by each of the plurality of program fragments, and a variable referred to by the variable, as the plurality of pieces of fragment order constraint information,
the processing circuitry creates a variable used by the control program, and a variable referred to by the variable, as the program order constraint information, and
the processing circuitry considers a program fragment corresponding to the fragment order constraint information as a similar program fragment when an order constraint indicated in each of the plurality of pieces of fragment order constraint information matches an order constraint indicated in the program order constraint information.

9. The program development support device as defined in claim 4, wherein the processing circuitry detects a variable whereof a value is changed by a side effect, and one or more line numbers to change the value of the variable for each line of a program list of the control program, and creates a list that associates the variable, the side effect and the one or more line numbers, as the program side effect list, and
the processing circuitry creates one or more line number sets that associate the plurality of fragment side effects of the program fragment and each line number of the one or more line numbers of the program list in a one-to-one correspondence, and when there is a line number set where all of the plurality of fragment side effects correspond to a program side effect that is obtained from different lines of the program list of the control program among the one or more line number sets, considers a program fragment corresponding to the fragment side effect list as the similar program fragment by regarding that one or more consistent line number sets exist.

10. The program development support device as defined in claim 9, wherein the processing circuitry creates a side effect combination list to combine each line number set of the one or more consistent line number sets of the plurality of similar program fragments, and when lines indicated in a plurality of line number sets of each combination in the side effect combination list correspond to different lines of the control program, estimates a combination of mechanism elements corresponding to the plurality of similar program fragments as a combination of consistent mechanism elements.

11. The program development support device as defined in claim 5, wherein the model database includes at least any of a block configuration diagram, an internal block diagram and a state transition diagram, as the mechanism element model.

12. A program development support method comprising:
in a program fragment database, registering a list of a plurality of fragment side effects indicating a plurality of side effects that are included in a program fragment corresponding to a mechanism element as a plurality of fragment side effects by associating the list of the plurality of fragment side effects with a plurality of program fragments;
analyzing a control program, and creating a program side effect list indicating a plurality of side effects that are included in the control program as a plurality of program side effects; and
comparing the plurality of program side effects indicated in the program side effect list, and the plurality of fragment side effects indicated in the list of the plurality of fragment side effects, and searching for a program fragment corresponding to the fragment side effect list where the plurality of fragment side effects are included in the plurality of program side effects, as a similar program fragment.

13. A non-transitory computer readable medium storing a program development support program to cause a computer including a program fragment database that registers a list of a plurality of fragment side effects indicating a plurality of side effects included in a program fragment corresponding to a mechanism element as a plurality of fragment side effects, by associating the list of the plurality of fragment side effects with a plurality of program fragments, to perform:
a program analysis process to analyze a control program, and to create a program side effect list indicating a plurality of side effects that are included in the control program as a plurality of program side effects; and
a similarity search process to compare the plurality of program side effects indicated in the program side effect list with the plurality of fragment side effects indicated in the list of the plurality of fragment side effects, and to search for a program fragment corresponding to a fragment side effect list where the plurality of fragment side effects are included in the plurality of program side effects, as a similar program fragment.
